(19) United States
(12) Patent Application Publication
(10) Pub. No.: US 2026/0222349 A1
(43) Pub. Date: Jul. 30, 2026

(54) ARTIFICIAL INTELLIGENCE NATIVE QUALITY OF SERVICE FLOW BINDING

(71) Applicant: QUALCOMM Incorporated, San Diego, CA (US)

(72) Inventors: Hong CHENG, Basking Ridge, NJ (US); Miguel GRIOT, La Jolla, CA (US)

(21) Appl. No.: 19/037,987

(22) Filed: Jan. 27, 2025

(51) Int. Cl. H04L 47/24; H04L 69/22

(52) U.S. Cl. CPC H04L 47/24; H04L 69/22

(57) ABSTRACT

Methods, systems, and devices for wireless communications are described. A user equipment (UE) may receive a first message identifying a quality of service (QoS) configuration associated with one or more QoS flows of a data session, the first message further identifying the QoS configuration as a flexible QoS configuration. The UE may transmit a second message identifying an updated QoS configuration for the one or more QoS flows based on performance metrics determined by the UE and the QoS configuration being a flexible QoS configuration, the updated QoS configuration being different from the QoS configuration and including an updated session binding. The UE may perform wireless communications for the data session using the one or more QoS flows according to the updated QoS configuration.

### FIELD OF TECHNOLOGY

The following relates to wireless communications, including artificial intelligence native quality of service flow binding.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a first message identifying a quality of service (QoS) configuration associated with one or more QoS flows of a data session, the first message further identifying the QoS configuration as a flexible QoS configuration, transmitting a second message identifying an updated QoS configuration for the one or more QoS flows based on performance metrics determined by the UE and the QoS configuration being a flexible QoS configuration, the updated QoS configuration being different from the QoS configuration and including an updated session binding, and performing wireless communications for the data session using the one or more QoS flows according to the updated QoS configuration.

A UE for wireless communications is described. The UE may include one or more memories storing processor executable code, and one or more processors coupled with the one or more memories. The one or more processors may individually or collectively be operable to execute the code to cause the UE to receive a first message identifying a QoS configuration associated with one or more QoS flows of a data session, the first message further identifying the QoS configuration as a flexible QoS configuration, transmit a second message identifying an updated QoS configuration for the one or more QoS flows based on performance metrics determined by the UE and the QoS configuration being a flexible QoS configuration, the updated QoS configuration being different from the QoS configuration and including an updated session binding, and perform wireless communications for the data session using the one or more QoS flows according to the updated QoS configuration.

Another UE for wireless communications is described. The UE may include means for receiving a first message identifying a QoS configuration associated with one or more QoS flows of a data session, the first message further identifying the QoS configuration as a flexible QoS configuration, means for transmitting a second message identifying an updated QoS configuration for the one or more QoS flows based on performance metrics determined by the UE and the QoS configuration being a flexible QoS configuration, the updated QoS configuration being different from the QoS configuration and including an updated session binding, and means for performing wireless communications for the data session using the one or more QoS flows according to the updated QoS configuration.

A non-transitory computer-readable medium storing code for wireless communications is described. The code may include instructions executable by one or more processors to receive a first message identifying a QoS configuration associated with one or more QoS flows of a data session, the first message further identifying the QoS configuration as a flexible QoS configuration, transmit a second message identifying an updated QoS configuration for the one or more QoS flows based on performance metrics determined by the UE and the QoS configuration being a flexible QoS configuration, the updated QoS configuration being different from the QoS configuration and including an updated session binding, and perform wireless communications for the data session using the one or more QoS flows according to the updated QoS configuration.

In some examples of the method, user equipment (UEs), and non-transitory computer-readable medium described herein, the second message includes a service data adaptation protocol (SDAP) message header and the method, apparatuses, and non-transitory computer-readable medium may include further operations, features, means, or instructions for transmitting the SDAP message header that indicates the updated session binding, the second message further indicating information associating the one or more QoS flows, one or more data radio bearers associated with the one or more QoS flows, or both, with the updated QoS configuration.

In some examples of the method, user equipment (UEs), and non-transitory computer-readable medium described herein, the second message may be configured to be forwarded by a radio network entity (RAN) to a user plane function (UPF) with a header indicating an updated session binding may be associated with one or more uplink packets of the data session.

In some examples of the method, user equipment (UEs), and non-transitory computer-readable medium described herein, the updated session binding associated with one or more uplink packets of the data session in the second message may be configured for use by a UPF to determine an updated session binding associated with one or more downlink packets of the data session.

In some examples of the method, user equipment (UEs), and non-transitory computer-readable medium described herein, the second message includes a QoS rule adjustment message that may be configured to be forwarded by a radio access network (RAN) to a session management function (SMF) within a core network.

In some examples of the method, user equipment (UEs), and non-transitory computer-readable medium described herein, the QoS rule adjustment message may be associated with service flow binding and mapping information updates for QoS flows having a flexible QoS configuration indicated in the first message.

In some examples of the method, user equipment (UEs), and non-transitory computer-readable medium described herein, the second message includes a QoS rule adjustment message that may be configured to be forwarded by a RANto a UPF within a core network.

In some examples of the method, user equipment (UEs), and non-transitory computer-readable medium described herein, the first message that indicates a flexible QoS configuration includes multiple alternative QoS rule sets and the updated QoS configuration indicates a QoS rule selected from the multiple alternative QoS rule sets by the UE based on the performance metrics determined by the UE.

In some examples of the method, user equipment (UEs), and non-transitory computer-readable medium described herein, the flexible QoS configuration configures the UE to determine, from a set of multiple mappings identified in the QoS configuration, service flow binding and mapping information.

A method for wireless communications by a network entity is described. The method may include outputting, to a UE, a first message identifying a QoS configuration associated with one or more QoS flows of a data session, the first message further identifying the QoS configuration as a flexible QoS configuration, obtaining, from the UE, a second message identifying an updated QoS configuration for the one or more QoS flows, the updated QoS configuration based on performance metrics associated with the UE and the QoS configuration being a flexible QoS configuration, the updated QoS configuration being different from the QoS configuration and including an updated session binding, and performing wireless communications for the data session using the one or more QoS flows according to the updated QoS configuration.

A network entity for wireless communications is described. The network entity may include one or more memories storing processor executable code, and one or more processors coupled with the one or more memories. The one or more processors may individually or collectively be operable to execute the code to cause the network entity to output, to a UE, a first message identifying a QoS configuration associated with one or more QoS flows of a data session, the first message further identifying the QoS configuration as a flexible QoS configuration, obtain, from the UE, a second message identifying an updated QoS configuration for the one or more QoS flows, the updated QoS configuration based on performance metrics associated with the UE and the QoS configuration being a flexible QoS configuration, the updated QoS configuration being different from the QoS configuration and including an updated session binding, and perform wireless communications for the data session using the one or more QoS flows according to the updated QoS configuration.

Another network entity for wireless communications is described. The network entity may include means for outputting, to a UE, a first message identifying a QoS configuration associated with one or more QoS flows of a data session, the first message further identifying the QoS configuration as a flexible QoS configuration, means for obtaining, from the UE, a second message identifying an updated QoS configuration for the one or more QoS flows, the updated QoS configuration based on performance metrics associated with the UE and the QoS configuration being a flexible QoS configuration, the updated QoS configuration being different from the QoS configuration and including an updated session binding, and means for performing wireless communications for the data session using the one or more QoS flows according to the updated QoS configuration.

A non-transitory computer-readable medium storing code for wireless communications is described. The code may include instructions executable by one or more processors to output, to a UE, a first message identifying a QoS configuration associated with one or more QoS flows of a data session, the first message further identifying the QoS configuration as a flexible QoS configuration, obtain, from the UE, a second message identifying an updated QoS configuration for the one or more QoS flows, the updated QoS configuration based on performance metrics associated with the UE and the QoS configuration being a flexible QoS configuration, the updated QoS configuration being different from the QoS configuration and including an updated session binding, and perform wireless communications for the data session using the one or more QoS flows according to the updated QoS configuration.

In some examples of the method, network entities, and non-transitory computer-readable medium described herein, the second message includes a SDAP message header and the method, apparatuses, and non-transitory computer-readable medium may include further operations, features, means, or instructions for obtaining the SDAP message header that indicates the updated session binding, the second message further indicating information associating the one or more QoS flows, one or more data radio bearers associated with the one or more QoS flows, or both, with the updated QoS configuration, where the second message may be forwarded by the network entity to a UPF with a header indicating an updated session binding may be associated with one or more uplink packets of the data session.

Some examples of the method, network entities, and non-transitory computer-readable medium described herein may further include operations, features, means, or instructions for obtaining an indication that the QoS configuration may be the flexible QoS configuration from a SMF within a core network associated with the network entity.

In some examples of the method, network entities, and non-transitory computer-readable medium described herein, the first message indicates a flexible packet filter for a QoS rule of the QoS configuration that may be set to a value that defines the QoS configuration as the flexible QoS configuration and the updated QoS configuration defines the QoS rule for the flexible packet filter having a threshold QoS precedence level.

In some examples of the method, network entities, and non-transitory computer-readable medium described herein, the flexible QoS configuration configures the UE to determine, from a set of multiple mappings identified in the QoS configuration, service flow binding and mapping information.

A method for wireless communications by a network entity within a core network is described. The method may include outputting, to a UPF within the core network, a session establishment message that identifies a flexible packet detection rule for a QoS configuration associated with one or more QoS flows of a data session for a UE, the flexible packet detection rule identifying the QoS configuration as a flexible QoS configuration and outputting, to a network entity associated with the UE, a message that identifies the QoS configuration, where the message further identifies the QoS configuration as the flexible QoS configuration.

A network entity within a core network for wireless communications is described. The network entity within a core network may include one or more memories storing processor executable code, and one or more processors coupled with the one or more memories. The one or more processors may individually or collectively be operable to execute the code to cause the network entity within a core network to output, to a UPF within the core network, a session establishment message that identifies a flexible packet detection rule for a QoS configuration associated with one or more QoS flows of a data session for a UE, the flexible packet detection rule identifying the QoS configuration as a flexible QoS configuration and output, to a network entity associated with the UE, a message that identifies the QoS configuration, where the message further identifies the QoS configuration as the flexible QoS configuration.

Another network entity within a core network for wireless communications is described. The network entity within a core network may include means for outputting, to a UPF within the core network, a session establishment message that identifies a flexible packet detection rule for a QoS configuration associated with one or more QoS flows of a data session for a UE, the flexible packet detection rule identifying the QoS configuration as a flexible QoS configuration and means for outputting, to a network entity associated with the UE, a message that identifies the QoS configuration, where the message further identifies the QoS configuration as the flexible QoS configuration.

A non-transitory computer-readable medium storing code for wireless communications is described. The code may include instructions executable by one or more processors to output, to a UPF within the core network, a session establishment message that identifies a flexible packet detection rule for a QoS configuration associated with one or more QoS flows of a data session for a UE, the flexible packet detection rule identifying the QoS configuration as a flexible QoS configuration and output, to a network entity associated with the UE, a message that identifies the QoS configuration, where the message further identifies the QoS configuration as the flexible QoS configuration.

Some examples of the method, networks entity within a core networks, and non-transitory computer-readable medium described herein may further include operations, features, means, or instructions for obtaining, from the UE, a QoS rule adjustment message that identifies an updated QoS configuration for the one or more QoS flows based on performance metrics associated with the UE, outputting, to the UPF, an updated packet detection rule in accordance with the updated QoS configuration, and outputting, to the network entity, a QoS profile update confirmation message according to the updated packet detection rule.

In some examples of the method, networks entity within a core networks, and non-transitory computer-readable medium described herein, the flexible packet detection rule identifies the QoS configuration as the flexible QoS configuration according to a set of alternative QoS flow identifies (QFIs), a set of alternative protocol data unit (PDU) session identifiers, or both.

In some examples of the method, networks entity within a core networks, and non-transitory computer-readable medium described herein, the flexible QoS configuration configures the UE to determine, from a set of multiple mappings identified in the QoS configuration, service flow binding and mapping information.

A method for wireless communications by a user plane network entity within a core network is described. The method may include obtaining, from a SMF network entity within the core network, a session establishment message that identifies a flexible packet detection rule for a QoS configuration associated with one or more QoS flows of a data session for a UE, the flexible packet detection rule identifying the QoS configuration as a flexible QoS configuration and outputting, to the SMF network entity, a response message that identifies the QoS configuration.

A user plane network entity within a core network for wireless communications is described. The user plane network entity within a core network may include one or more memories storing processor executable code, and one or more processors coupled with the one or more memories. The one or more processors may individually or collectively be operable to execute the code to cause the user plane network entity within a core network to obtain, from a SMF network entity within the core network, a session establishment message that identifies a flexible packet detection rule for a QoS configuration associated with one or more QoS flows of a data session for a UE, the flexible packet detection rule identifying the QoS configuration as a flexible QoS configuration and output, to the SMF network entity, a response message that identifies the QoS configuration.

Another user plane network entity within a core network for wireless communications is described. The user plane network entity within a core network may include means for obtaining, from a SMF network entity within the core network, a session establishment message that identifies a flexible packet detection rule for a QoS configuration associated with one or more QoS flows of a data session for a UE, the flexible packet detection rule identifying the QoS configuration as a flexible QoS configuration and means for outputting, to the SMF network entity, a response message that identifies the QoS configuration.

A non-transitory computer-readable medium storing code for wireless communications is described. The code may include instructions executable by one or more processors to obtain, from a SMF network entity within the core network, a session establishment message that identifies a flexible packet detection rule for a QoS configuration associated with one or more QoS flows of a data session for a UE, the flexible packet detection rule identifying the QoS configuration as a flexible QoS configuration and output, to the SMF network entity, a response message that identifies the QoS configuration.

Some examples of the method, user plane networks entity within a core networks, and non-transitory computer-readable medium described herein may further include operations, features, means, or instructions for obtaining, from the UE, a user plane packet that indicates a reflective flow mapping update, determining, based on the user plane packet, an updated binding associated with one or more uplink packets of the data session, and applying the updated binding to one or more downlink packets of the data session.

Some examples of the method, user plane networks entity within a core networks, and non-transitory computer-readable medium described herein may further include operations, features, means, or instructions for obtaining, from the UE, an QoS rule adjustment message associated with one or more uplink packets of the data session and updating one or more downlink packet detection rules associated with the QoS configuration in accordance with the QoS rule adjustment message.

In some examples of the method, user plane networks entity within a core networks, and non-transitory computer-readable medium described herein, the flexible packet detection rule identifies the QoS configuration as the flexible QoS configuration according to a set of alternative QFIs, a set of alternative PDU session identifiers, or both.

In some examples of the method, user plane networks entity within a core networks, and non-transitory computer-readable medium described herein, the flexible QoS configuration configures the UE to determine, from a set of multiple mappings identified in the QoS configuration, service flow binding and mapping information.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports artificial intelligence (AI) native quality of service (QoS) flow binding in accordance with one or more aspects of the present disclosure.

FIG. 2 shows an example of a wireless communications system that supports AI native QoS flow binding in accordance with one or more aspects of the present disclosure.

FIG. 3 shows an example of a wireless communications system that supports AI native QoS flow binding in accordance with one or more aspects of the present disclosure.

FIG. 4 shows an example of a swim diagram that supports AI native QoS flow binding in accordance with one or more aspects of the present disclosure.

FIGS. 5 and 6 show block diagrams of devices that support AI native QoS flow binding in accordance with one or more aspects of the present disclosure.

FIG. 7 shows a block diagram of a communications manager that supports AI native QoS flow binding in accordance with one or more aspects of the present disclosure.

FIG. 8 shows a diagram of a system including a device that supports AI native QoS flow binding in accordance with one or more aspects of the present disclosure.

FIGS. 9 and 10 show block diagrams of devices that support AI native QoS flow binding in accordance with one or more aspects of the present disclosure.

FIG. 11 shows a block diagram of a communications manager that supports AI native QoS flow binding in accordance with one or more aspects of the present disclosure.

FIG. 12 shows a diagram of a system including a device that supports AI native QoS flow binding in accordance with one or more aspects of the present disclosure.

FIGS. 13 through 16 show flowcharts illustrating methods that support AI native QoS flow binding in accordance with one or more aspects of the present disclosure.

### DETAILED DESCRIPTION

Wireless networks may support data session(s) between user equipment (UE) and an access function (AF), such as an end-user server or other online service. This may include the core network establishing quality of service (QoS) flow(s) (e.g., protocol data unit (PDU) session(s)) to support data traffic in the data session being communicated within the core network. At the radio access network (RAN) level (e.g., at the network entity performing the wireless communications with the UE), this may include data radio bearer(s) (DRB(s)) being established for the corresponding QoS flow(s) for the physical layer wireless communications. However, such networks generally manage the bindings (e.g., the QoS flows-to-data session binding and the QoS flow-to-DRB binding) associated with the data session and may not provide a mechanism where the UE may provide input to such bindings or other mappings related to the data session.

Accordingly, aspects of the techniques described herein provide for a native QoS management function at the UE collaborating with the core network and the RAN that provides more flexibility and UE-centric control. For example, the UE may receive or otherwise obtain a first message identifying a QoS configuration associated with one or more QoS flows of a data session. The first message further may identify the QoS configuration as a flexible QoS configuration. In some examples, the flexible QoS configuration may configure the UE to determine, from a plurality of mappings identified in the QoS configuration, a session binding associated with the one or more QoS flows. The UE may transmit a second message identifying an updated QoS configuration for the one or more QoS flows based on performance metrics determined by the UE and the QoS configuration being a flexible QoS configuration. In some aspects, the updated QoS configuration may be different from the QoS configuration and include an updated session binding associated with the one or more QoS flows. The UE may perform wireless communications for the data session using the one or more QoS flows according to the updated QoS configuration and the updated session binding. Correspondingly, the core network and the RAN may provide QoS to the UE's data session according to the updated session binding.

Aspects of the disclosure are initially described in the context of wireless communications systems. Aspects of the disclosure are further illustrated by and described with reference to apparatus diagrams, system diagrams, and flowcharts that relate to AI native QoS flow binding.

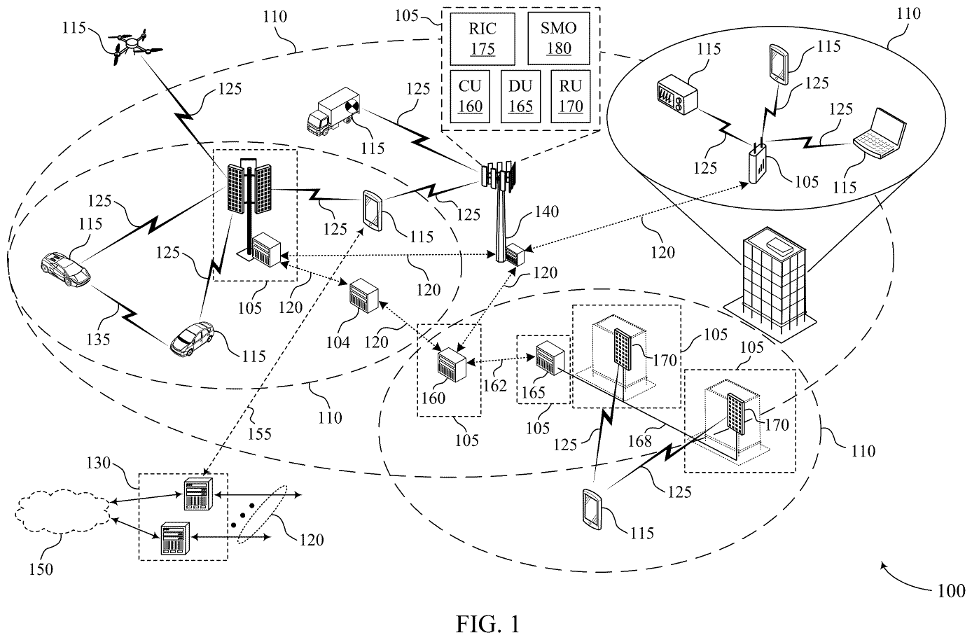

FIG. 1 shows an example of a wireless communications system 100 that supports AI native QoS flow binding in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein. In some examples, the core network 130 may include various components, functions, or otherwise support features related to an evolved packet switching (EPS), a fifth generation core network (5GC), or other components associated with wireless communications with the UE 115.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support AI native QoS flow binding as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an EPC or 5GC, which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User traffic, e.g., IP packets, Ethernet packets, or unstructured packets, may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service. The user plane entity may also provide connectivity to Ethernet or other types of network services.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive from a network entity, e.g., a core network control function, a first message identifying a QoS configuration associated with one or more QoS flows of a data session, the first message further identifying the QoS configuration as a flexible QoS configuration. The UE 115 may transmit a second message identifying an updated QoS configuration for the one or more QoS flows based on performance metrics determined by the UE 115 and the QoS configuration being a flexible QoS configuration, the updated QoS configuration being different from the QoS configuration and including an updated session binding associated with the one or more QoS flows of the data session. The UE 115 may perform wireless communications for the data session using the one or more QoS flows according to the updated QoS configuration.

A network entity 105 or other entities (e.g., one or more entities within the core network 130) may output, to a UE 115, a first message identifying a QoS configuration associated with one or more QoS flows of a data session, the first message further identifying the QoS configuration as a flexible QoS configuration. The network entity 105 or entities may receive, from the UE 115, a second message identifying an updated QoS configuration for the one or more QoS flows, the updated QoS configuration based on performance metrics associated with the UE 115 and the QoS configuration being a flexible QoS configuration, the updated QoS configuration being different from the QoS configuration and including an updated session binding. In some examples, the first message may be received from an SMF via a user plane (e.g., the first message may be transparent to the RAN based on NAS signaling). The network entities may perform wireless communications for the data session using the one or more QoS flows according to the updated QoS configuration. For example, one or more entities within the core network 130 (e.g., UPF) may perform wireless communications for the data session with the UE 115 via the RAN (e.g., the network entity 105).

A network entity within a core network (e.g., a session management function SMF) network entity, a policy control function (PCF) network entity, or both entities within the core network 130) may output, to a UPF within the core network, a session establishment message or a session modification message that identifies a flexible packet detection rule for a QoS configuration associated with one or more QoS flows of a data session for a UE 115, the flexible packet detection rule identifying the QoS configuration as a flexible QoS configuration. The network entity may output, to a network entity 105 associated with the UE 115, a message that identifies the QoS configuration, wherein the message further identifies the QoS configuration as the flexible QoS configuration. In some cases, the message to the network entity 105 may contain the first message that would be forwarded by the network entity 105 to the UE 115.

A user plane network entity within a core network (e.g., a UPF within the core network 130) may obtain, from a SMF network entity within the core network, a session establishment message that identifies a flexible packet detection rule for a QoS configuration associated with one or more QoS flows of a data session for a UE 115, the flexible packet detection rule identifying the QoS configuration as a flexible QoS configuration. The network entity may output, to the SMF network entity, a response message that identifies the QoS configuration is accepted and applied.

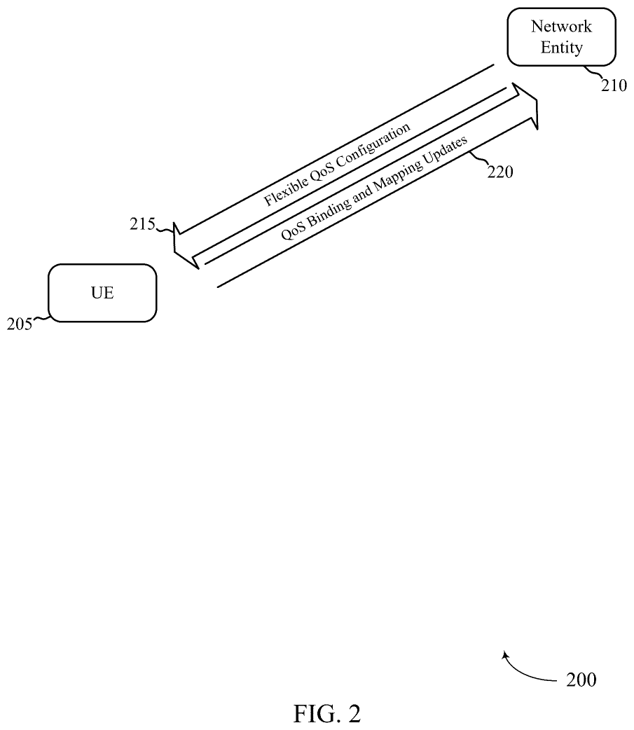

FIG. 2 shows an example of a wireless communications system 200 that supports AI native QoS flow binding in accordance with one or more aspects of the present disclosure. Aspects of the wireless communications system 200 may implement aspects of or be implemented by aspects of the wireless communications system 100. The wireless communications system 200 may include a UE 205 and a network entity 210, which may be examples of the corresponding devices described herein. In some examples, the network entity 210 may represent a combination of multiple network entities, e.g., network entity 105, SMF, PCF, or UPF 130.

Aspects of the wireless communications system 200 may include artificial intelligence (AI) native support for non-access stratum (NAS) layer design. For example, the wireless communications system 200 may include assistance from the UE 205 for the upper layer operation parameter determination. The UE may use the AI techniques to determine the most appropriate operation parameters satisfying the application needs and user experience. The AI techniques may include for example the local detection of the user behavior, attending to a particular application or contents, environmental factors, etc. Based on these factor(s), the AI techniques may decide if certain operation parameters need to be updated, e.g., change of certain QoS parameters, or change the binding of certain data sessions with a QoS Flow.

For example, a data session may be established between the UE 205 and an AF to communicate uplink data, downlink data, or both uplink and downlink data. The AF in this example, may be any end-user server, function, another UE, or operation that is communicating data with the UE 205 via a core network. For example, the network entity 210 may be an example of a RAN access where the UE 205 communicates wirelessly over the physical channel (e.g., via a Uu interface, a PC5 interface, or via a Wi-Fi interface, or a combination of the interfaces). The network entity 210 may be operable and communicatively coupled with component(s) of the core network that manage aspects of the data being communicated in the data session.

This may include a policy control function (PCF) within the core network that manages aspects of the data session binding (e.g., the rules for the binding or mapping between the data session and PDU session(s) and QoS flow(s) within the core network, and determining the corresponding treatment (e.g., QoS parameters) as well as a SMF within the core network that manages aspects of the QoS flow binding (e.g., applies the rules to map or otherwise bind the data session to the QoS flow(s) within the core network. The network entity 210 may manage aspects of the mapping or binding between the QoS flow(s) and data radio bearer(s) (DRB)(s) used to communicate the data over the physical channel. The network entity 210 may configure the UE 205 with a service data adaptation protocol (SDAP) layer configuration and the QoS rules to be used for the data session. The network entity 210 may manage the mapping or binding based on the instructions from the SMF. The QoS rules to the UE 205 may also be provided to the network entity 210 by the core network entity, e.g., SMF. In some wireless networks, the binding or mapping decisions (e.g., the QoS configuration) are managed by the components within the core network or the network entity 210 and without UE involvement.

More particular, in some cases the data session binding and QoS flow binding/PDU session may be implemented by the PCF and the SMF. For example, two layers of binding/associations may be carried out within the core network to place a data session with an AF to a PDU session and the corresponding QoS flows. This may include the PCF performing the session binding to the PDU session(s) and this may be based on for example, an identifier of the UE 205, a data network name (DNN)/single network slice selection assistance information (S-NSSAI), IP address used, AF identity, service types, or other related information. This may include the SMF performing the QoS flow binding (e.g., to associate the data flows identified by the PCC rules to the different QoS flows within a PDU session and determine corresponding the QoS parameters, various flags, or other related information). This may include the RAN determining the QoS flow mapping to the radio bearers (e.g., the SDAP configuration information and the needed logical channel configurations).

However, there are some issues with respect to such operations being performed without involvement of the UE. The fixed network determination of the data session binding to the QoS flows/radio bearers may not take the actual user preference or performance and QoE into consideration. For example, when access traffic steering, switching, and splitting (ATSSS) or a multi-access session management for ATSSS (MASSS) feature is used, the UE 205 may have more than one access paths (e.g., a RAN-based access via the network entity 210 and a non-3GPP access, such as a Wi-Fi access) to consider for the session binding. The network, especially core network, may not always have the accurate information to decide the best binding for this multi-access situation.

Accordingly, aspects of the techniques described herein provide for input from the UE 205 based on an AI or machine learning (ML) operations or functions within the UE 205 to help the network improve operation efficiency and quality of experience (QoE) for the user. For example, the aspects of the QoS control that may be improved using the AL/ML based UE input include improved session binding (e.g., determination of the mapping of service data flows to QoS flows and QoS flows to resource blocks (RBs). This may include the case of a dynamic switching of flows among multiple paths (e.g., fast ATSSS and MASSS).

For example, at 215 this may include the network entity 210 transmitting or otherwise outputting (and the UE 205 receiving or otherwise obtaining) a first message that carries or otherwise conveys information that identifies a QoS configuration associated with QoS flow(s) of a data session. In some aspects, the first message may also carry or otherwise convey information that identifies the QoS configuration as a flexible QoS configuration. For example, the flexible QoS configuration may include an indication that indicates the UE 205 is allowed to determine the data flow binding and mappings for the associated QoS Flows and data sessions. In another example, the indication may be presented with a plurality of mappings identified in the QoS configuration, each including service flow binding and mapping information for the data session. In some aspects, the first message may carry or otherwise convey information that indicates a flexible QoS configuration by including an indication of multiple alternative QoS rule sets associated with a QoS Flow. Alternatively, the QoS configuration may include a list of QoS rule sets that identify the corresponding data flows, with each associated with multiple alternative QoS Flow IDs. For example, in some aspects the first message may indicate that the packet filter sets for a QoS rule of the QoS configuration being the flexible, and the UE 205 is allowed to change them. The flexible QoS configuration may also include the criteria, e.g., a threshold of QoE, or performance parameters for the UE to change the mappings. The flexible QoS configurations may also include precedence levels associated with the alternative configurations for the mappings, so that the UE determine how to make the updates.

In some aspects, this may include the RAN (e.g., the RAN-based access provided by the network entity 210) providing a flexible SDAP configuration to the UE 205. For example, the flexible SDAP configuration may include a SDAPconfig header that includes a flexible QoS flows to add parameter (FlexibleQoS-FlowsToAdd). Broadly, the UE 205 may use the flexible QoS flow to add parameter to determine the best DRB(s) to carry the corresponding QoS flow(s). In some aspects, this may be used for the uplink traffic handling directly. In some aspects, this may be used to influence the downlink traffic association (e.g., the UE 205 may use explicit signaling for the downlink traffic adaptations or may use an uplink packet with a reflective indicator, such as a reverse reflective QoS indicator).

For example, at 220 the UE 205 may transmit or otherwise output (and the network entity 210 may receive or otherwise obtain) a second message that carries or otherwise conveys information identifying an updated QoS configuration for the QoS flow(s). In some aspects, the updated QoS configuration may be based on various performance metric(s) associated with the UE 205 as well as the QoS configuration being a flexible configuration. Thus, in this aspect the UE 205 may provide an indication of the updated QoS configuration that changes various parameter(s) of the QoS configuration so as to be different from the QoS configuration signaled in the first message. The UE 205 and the network entity 210 may perform wireless communications for the data session using the QoS flow(s) according to the updated QoS configuration. That is, the wireless network may make various changes or updates to the QoS flow(s) using the updated parameter(s) indicated in the updated QoS configuration identified and signaled by the UE 205. In some examples, the second message is a part of the data communication traffic between the UE and the network, e.g., a packet from the UE 205 to the AF.

In some aspects, the QoS configuration being a flexible QoS configuration may be based on various signaling operations or determinations made by or in cooperation with various network entities within the core network associated with the UE 205 and the network entity 210. For example, the SMF network entity (e.g., the SMF), the PCF network entity (e.g., the PCF), or both entities within the core network may transmit or otherwise output (and a UPF within the core network may receive or otherwise obtain) a session establishment message (e.g., a PDU session establishment message) that carries or otherwise conveys information identifying a flexible packet detection rule for a QoS configuration. The QoS configuration may be associated with QoS flow(s) of a data session for the UE 205. The UPF may provide a response message to the SMF, to the PCF, or to both network entities within the core network that carries or otherwise conveys information that identifies the QoS configuration. In some aspects, the UPF may provide a notification message to the SMF, PCF, or both, to indicate an updated QoS configuration. In some aspects, the flexible packet detection rule may identify or otherwise define the QoS configuration as the flexible QoS configuration (e.g., a QoS configuration that may be changed or otherwise updated by the UE 205).

In some aspects, the SMF, the PCF, or both, may transmit or otherwise output (and the network entity 210 may receive or otherwise obtain) a message that configures or otherwise identifies the QoS configuration. The message may carry or otherwise convey information that identifies the QoS configuration as the flexible configuration.

For example, this may provide a more flexible and UE-centric approach to QoS flow configurations. This may include the SMF providing a flexible QoS configuration to the UE 205 (e.g., via the message provided to the network entity 210). The message may include one or more parameter sets associated with a QoS flow identifier (QFI). The parameter set may include a QoS flow level parameters element that includes parameters relating to the 5G QoS identifier (5QI), the data rate, the aggregate maximum bit rate (AMBR), or other parameters. The parameter set may also include a QoS rules element that includes parameters related to a QoS rule identifier and a packet filter set. The QoS rule identifier and packet filter set may have an alternative QFI(s) parameter and an alternative PDU session identifier parameter associated. The UE 205 may use this information to determine the best QoS flow identified by a QFI (e.g., the updated QoS configuration) to associate the service data flow with (e.g., in terms of dynamic metrics or requirements). The UE 205 may use this information to determine the uplink traffic association handing directly. The UE 205 may use this information to determine or otherwise influence the downlink traffic association at the network entities using explicit signaling or using an uplink data packet with a reflective indicator (e.g., a reverse reflective QoS indicator).

In some aspects, this operation may include for each service data flow identified by the PCC rule bound to a QoS flow, when applicable, the SMF generating an explicitly signaled QoS rule according to various principles and provides it to the UE 205 together with an add operation. This may include a unique (e.g., for the PDU Session) QoS rule identifier being assigned. The QFI in the QoS rule may be set to the QFI of the QoS flow to which the PCC rule is bound. The packet filter set of the QoS rule may be generated from the uplink service data flow (SDF) filter(s) and optionally the downlink SDF filter(s) of the PCC rule (e.g., only from those SDF filters that have an indication for being signaled to the UE 205). The QoS rule precedence value may be set to the precedence value of the PCC rule for which the QoS rule is generated. The QoS flow level QoS parameters (e.g., 5QI, GFBR, MFBR, Averaging Window, or other related information) may be signaled to UE 205 in addition to the QoS rule(s) associated to the QoS Flow (which may collectively be referred to as the QoS configuration).

In order to indicate that the QoS flow is subject to a flexible packet filter association (e.g., a flexible QoS configuration), the SMF may create a flexible QoS rule with an indication of a flexible Packet filter set. This may include defining a specific value(s) for the packet filter identifiers reserved for flexible configuration or by an explicit indication. This may include a flexible QoS rule precedence.

In some aspects, the UE 205 may use this information in various ways. For example, the UE 205 may review or otherwise go through the QoS rules in order of presence and, if it finds a matching packet filter before finding a QoS rule allowing for flexible selection of that QoS flow, the UE 205 may use the packet filter received from the SMF and may not apply flexible selection. This allows the SMF to bind certain packet filters to specific QoS flows (this may not allow flexibility for those packet filters) and allow flexibility for others. If the UE 205 finds a QoS rule that indicates a flexible packet filter for a QoS flow (before a matching packet filter), the UE 205 may decide whether this QoS flow is suitable. This may be based in part on the QoS flow level QoS parameters. If this QoS flow is suitable, the UE 205 may decide to associate this traffic to the indicated QoS flow, and effectively create a QoS rule with this packet filter and QoS rule precedence equal to the flexible QoS rule precedence. For example, the flexible packet detection rule may identify the QoS configuration as the flexible QoS configuration according to a set of alternative QFIs, a set of alternative PDU session identifiers, or both. If on the other hand, the UE 205 decides that this traffic is not suitable for association with the QoS flow, it may continue search for other matching flexible packet filter(s) for the traffic. This effectively changed the QoS rule associations. It is also possible for the UE 205 to mark a QoS configuration as flexible after initially determining that the QoS flow is suitable for the traffic, and trigger a re-evaluation based on local logic, e.g., AI model decisions. The re-evaluation may result in the UE change the association of the QoS rules to another QoS Flow. If the UE 205 determines a flexible QoS configuration different from the received QoS configuration, e.g., not associating the data traffic to the first QoS Flow with the matching flexible packet filter, or modified the association of the QoS Flow(s), the UE 205 indicates the binding and mapping updates in a message 220 to the network entity 210. The message 220 may be an explicit signaling message, or an uplink data packet with an indication of mapping change in the header(s).

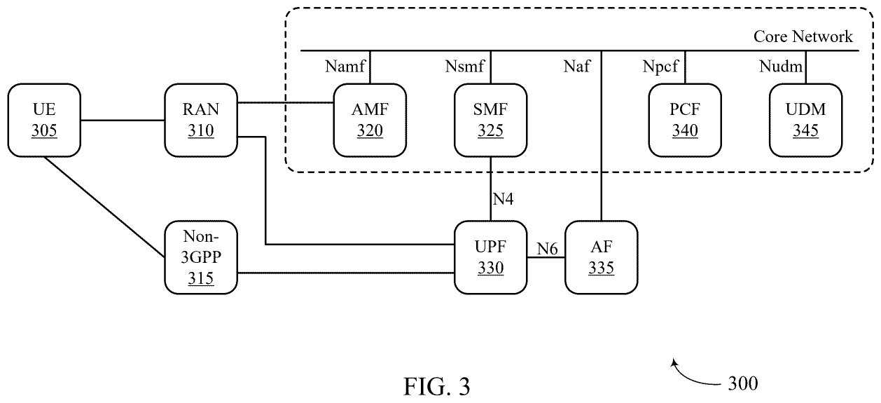

FIG. 3 shows an example of a wireless communications system 300 that supports AI native QoS flow binding in accordance with one or more aspects of the present disclosure. Aspects of the wireless communications system 300 may be implemented at or implemented by aspects of the wireless communications system 100 or the wireless communications system 200. Aspects of the wireless communications system 300 may include a UE 305, a RAN access 310, a non-3GPP access 315, an AMF 320, a SMF 325, a UPF 330, a PCF 340, and a UDM 345, which may be examples of the corresponding devices described herein. For example, the AMF 320, the SMF 325, the PCF 340, and the UDM 345 may be examples of network entities within a core network. The RAN access 310 may be an example of a network entity (e.g., a network entity 210) performing wireless communications with the UE 305 via a cellular wireless network (e.g., such as via a 3GPP-based wireless network).

As discussed above, aspects of the techniques described herein provide for various techniques for utilization of UE-based information to update or otherwise select a QoS configuration (e.g., binding, rule, or other mapping information associated with a data session). For example, the UE 305 may connect to the AF 335 via the core network using either the RAN access 310 or the non-3GPP access 315. The UE 305 may establish the connection to the core network to communicate data during a data session established between the UE 305 and the AF 335. Various binding or other mapping configurations or rules may be used to establish QoS flow(s) within the core network (e.g., based on PCC rules established by the PCF 340), which may also include PDU session(s), and to establish DRB(s) that correspond to the QoS flows and manage the physical radio bearers between the UE 305 and the RAN access 310 or the non-3GPP access 315. The DRB(s) may be configured as part of the SDAP signaling between the RAN access 310 (in this example) and the UE 305.

For example, this may include the SMF 325 or the PCF 340 transmitting or otherwise outputting (and the UPF 330 receiving or otherwise obtaining) a session establishment message that identifies a flexible PDR for a QoS configuration associated with QoS flow(s) of a data session of the UE 305. In some aspects, the flexible PDR may define or otherwise identify the QoS configuration as a flexible configuration. With the flexible PDR, the UPF 330 may allow the UE inputs in determining the binding and mapping of the traffic to the QoS Flow(s). For example, the PCF 340 may identify, select, or otherwise determine various rules for the QoS flow(s) supporting the data session communications and provide this information to the SMF 325. For each PCC rule bound to a QoS flow, when applicable, the SMF 325 may generate an explicitly signaled QoS rule according to various principles and provide this rule it to the UE together with an add operation.

This may include a unique (e.g., for the PDU session) QoS rule identifier being assigned. The QFI in the QoS rule may be set to the QFI of the QoS flow to which the PCC rule is bound. The packet filter set of the QoS rule (e.g., the flexible PDR) may be generated from the uplink SDF filters and the downlink SDF filters of the PCC rule (e.g., from those SDF filters that have an indication for being signaled to the UE 305). The QoS rule precedence value may be set to the precedence value of the PCC rule for which the QoS rule is generated. The QoS flow level QoS parameters (e.g., 5QI, GFBR, MFBR, averaging window, or other related information) are signaled to UE 305 in addition to the QoS rule(s) associated to the QoS flow. To indicate that QoS flow is subject to a flexible packet filter association, the SMF 325 may create a flexible QoS rule with an indication of flexible packet filter set (e.g., by defining a specific value for the packet filter reserved for flexible value(s) or by an explicit indication) or an indication of a flexible QoS rule precedence.

The UPF 330 may transmit or otherwise output (and the SMF 325 may receive or otherwise obtain) a response message that identifies the QoS configuration is accepted and applied. The UPF 330 may transmit or otherwise output (and the SMF 325 may receive or otherwise obtain) a notification message that indicating a change in the QoS configuration. The SMF 325 may, therefore, transmit or otherwise output a message that identifies the QoS configuration and indicates or otherwise identifies the QoS configuration as the flexible QoS configuration. For example, the SMF 325 may provide information indicative of or otherwise associated with the QoS configuration and the indication that the QoS configuration is a flexible QoS configuration to the RAN access 310. For example, the SMF 325 may indicate the (flexible) QoS configuration to the RAN access 310 by signaling, within a QFI header, various QoS flow parameters as well as QoS rules. The QoS rule (information element) may include a QoS rule identifier and packet filter set indication, and include a list of alternative QFIs, alternative PDU session identifiers, or both information. Listing the alternative QFIs/PDU session identifiers may provide the indication that the QoS configuration (e.g., corresponding to the QFI) is flexible and can be modified by the UE 305. The UE 305 is allowed to select from the one or more of the alternative QFIs/PDU session identifiers for the data flow binding and mapping, and the UE 305 can signal such change of binding and mapping to the network. Accordingly, in some aspects the flexible PDR to the UPF 330 identifies the QoS configuration as the flexible QoS configuration according to a set of alternative QFIs, a set of alternative PDU session identifiers, or both.

The RAN access 310 may transmit or otherwise output (and the UE 305 may receive or otherwise obtain) a first message that identifies the QoS configuration for the QoS flow(s) of the data session and also identifies that the QoS configuration is the flexible QoS configuration. In some examples, the first message in this context may include an AS layer message (e.g., an RRC message). In other example, the first message may refer to NAS layer message(s) exchanged between the UE 305 and core network component(s) or function(s). In some aspects, the first message may include a SDAP message header that carries or otherwise conveys an SDAP configuration to the UE 305. The SDAP configuration may include a flexible QoS flows to add parameter (FlexibleQoS-FlowsToAdd) that allows the UE 305 to determine the best DRB(s) to carry the corresponding QoS flows. In some aspects, the first message may carry or otherwise convey an indication of multiple alternative QoS rule sets such that the UE 305 may select the updated QoS configuration that indicates a QoS rule that has been selected from the multiple QoS alternative rule sets (e.g., multiple flexible packet filter sets). In some aspects, the first message may include a container that includes the QoS configuration information from the SMF 325 to the UE 305. The RAN access 310 does not process or need to understand the information inside the container.

The UE 305 may transmit or otherwise output (and the RAN access 310 may receive or otherwise obtain) a second message that carries or otherwise conveys information that identifies an updated QoS configuration for the QoS flow(s). The UE 305 may identify or otherwise select the updated QoS configuration based on various performance metrics associated with, identified or otherwise determined by, the UE 305 and based on the QoS configuration being a flexible QoS configuration (e.g., being a QoS configuration that can be changed, updated, or otherwise modified based on input from the UE 305). Accordingly, the flexible QoS configuration may be different from the QoS configuration that was provided in the first message. The UE 305 and the RAN access 310 may perform wireless communications for the data session using the QoS flow(s) according to the updated QoS configuration. For example, the QoS flow(s) being used to communicate data during the data session may be updated, changed, or reselected based on the indication provided by the UE 305 in the second message. Further options for updating the QoS configuration to the updated QoS configuration are described below.

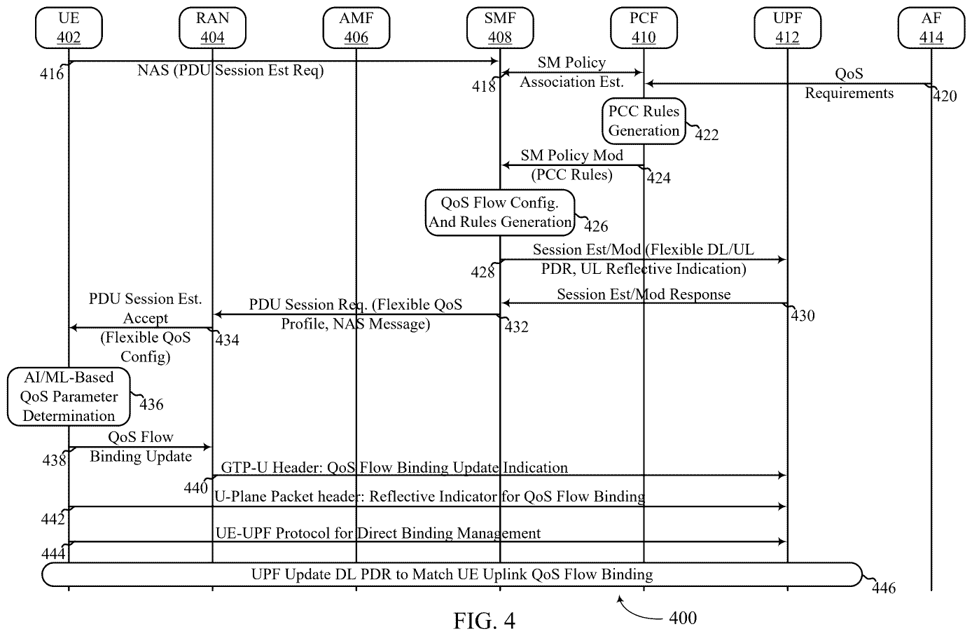

FIG. 4 shows an example of a swim diagram 400 that supports AI native QoS flow binding in accordance with one or more aspects of the present disclosure. Aspect of the swim diagram 400 may be implemented at or implemented by aspects of the wireless communications system 100, the wireless communications system 200, or the wireless communications system 300. Aspects of the swim diagram 400 may be implemented at or implemented by a UE 402, a RAN access 404, an AMF 406, a SMF 408, a PCF 410, a UPF 412, and an AF 414, which may be examples of the corresponding devices described herein. Swim diagram 400 illustrates an example of signaling details for SMF-to-UE, UE-to-RAN, and UE-to-UPF signaling according to the techniques described herein.

At 416, the UE 402 may transmit or otherwise output (and the SMF 408 may receive or otherwise obtain) a PDU session establishment request message. The PDU session establishment request message may be configured according to or as part of the NAS signaling between the UE 402 and the SMF 408. The PDU session establishment request message may be provided to the SMF 408 via the RAN access 404, in some aspects. The PDU session establishment request message may be used to establish a PDU session for a data session between the UE 402 and the AF 414.

At 418, the SMF 408 and the PCF 410 may exchange one or more messages regarding a session management (SM) policy association establishment. These messages may be exchanged to determine that PDU session(s) are to be established for the data session. This information will be used to establish the binding and mapping information for the QoS flow(s) and the DRB(s) that are constructed, configured, or otherwise operate to communicate data during the data session. In some aspects, at 420 the PCF 410 may receive or otherwise obtain (and the AF 414 may transmit or otherwise output) an indication of the QoS requirements associated with the data session. For example, the QoS requirements may be based on the latency requirements, QoE requirements, priority level, or other factors or considerations relating to the data being communicated during the data session. In some aspects, the PCF 410 may receive the QoS requirements from the AF 414 via a network exposure function (NEF). In another aspect, the AF 414 may provide the QoS requirements to a network data repository, e.g., a UDR, directly or via a NEF, before the UE starts the PDU session establishment. The PCF 410 may obtain the QoS requirements from the UDR when it receives the request from the SMF 408.

At 422, the PCF 410 may generate one or more PCC rules for the data session between the UE and the AF, with corresponding QoS requirements. For example, the PCF 410 may establish the PCC rules in order to comply with the QoS requirements of the data session. At 424, the PCF 410 may transmit or otherwise output (and the SMF 408 may receive or otherwise obtain) a message indicating the SM policy modification. The SM policy modification may include the PCC rules established by the PCF 410.

At 426, the SMF 408 may generate the QoS flow configuration(s) and rules for the QoS flow(s) being established for the data session (e.g., the QoS Flow(s) for the PDU session(s)). For example, the SMF 408 may generate the configurations for the QoS flow(s) to be established for the data session according to the PCC rules provided by the PCF 410.

At 428, the SMF 408 may transmit or otherwise output (and the UPF 412 may receive or otherwise obtain) a PDU session establishment/modification message. The PDU session establishment/modification message may include a session establishment message that identifies a flexible PDR for a QoS configuration associated with the QoS flow(s) of the data session for the UE 402. The flexible PDR may carry or otherwise convey information that identifies the QoS configuration as a flexible QoS configuration. For example, the session establishment message may carry or otherwise convey the flexible PDR that may be applicable to uplink traffic, downlink traffic, or both uplink and downlink traffic as well as an uplink reflective indication. For example, the flexible PDR may identify the QoS configuration as being a flexible QoS configuration according to a set of alterative QFIs, a set of alternative PDU session identifiers, or both sets.

At 430, the UPF 412 may transmit or otherwise output (and the SMF 408 may receive or otherwise obtain) a response message that identifies the QoS configuration had been accepted or applied. For example, the response message may be a PDU session establishment/modification response message that confirms the QoS configuration for the SMF 408.

At 432, the SMF 408 may transmit or otherwise output (and the RAN access 404 may receive or otherwise obtain) a PDU session request message that identifies the QoS configuration (e.g., a flexible QoS profile(s)). The PDU session request message may be used by the SMF 408 to signal the QoS configuration to the network entity associated with the UE 402 as well as to indicate that at least one (or one or more) QoS configurations associated with the data session of the PDU session are flexible and may be updated based on signaling from the UE 402.

At 434, the RAN access 404 may transmit or otherwise output (and the UE 402 may receive or otherwise obtain) a PDU session establishment accept message that confirms establishment of the PDU session for the data session with the AF 414. In some aspects, this may include the network entity transmitting a first message to the UE 402 that identifies the QoS configuration associated with the QoS flow(s) of the data session where the first message identifies the QoS configuration as a flexible configuration. This PDU session establishment accept message to the UE 402 may be a NAS layer message from the SMF 408. The NAS message may be included in the PDU Session request message sent from the SMF 408 to the RAN access 404, using a container. Alternatively, the NAS message may be sent from SMF 408 to RAN access 404 using a dedicated N2 transport message. The RAN access 404 does not modify the NAS message to the UE 402. The RAN access 404 may use an RRC message, e.g., RRCReconfiguration message, to transfer the NAS message to the UE 402. The RRC message may also contain the configuration of the DRB(s) used to transport the QoS Flow(s) of the QoS configuration sent to the UE. After a successful configuration of the UE 402 via the first message, the RAN access 404 may transmit a response message towards SMF 408, indicating the results of the establishing the PDU session and corresponding QoS Flows. This may further trigger SMF 408 to interact with UPF 412 to update QoS Configurations or other settings if necessary.

At 436, the UE 402 may select, identify, or otherwise determine various QoS parameters (e.g., updated QoS parameters) for the QoS flow(s) being used for the data session. For example, the UE 402 may include an AI/ML model to learn or otherwise identify the QoS parameters to be used for the QoS flow(s). Thus, the UE 402 may transmit a second message identifying an updated QoS configuration for the QoS flow(s) based on the performance metric(s) associated with the UE 402. The UE 402 and the RAN access 404 may perform wireless communications for the data session using the QoS flow(s) according to the updated QoS configuration. Broadly, swim diagram 400 illustrates three non-limiting examples of how the UE 402 may update the QoS configuration for the QoS flow(s).

A first option may include 438 where the UE 402 transmits or otherwise outputs (and the RAN access 404 receives or otherwise obtains) the second message. In this example, the second message includes an SDAP message header that indicates the session binding is updated (e.g., the QoS flow binding update). For example, the second message may include information that maps or otherwise associates the QoS flow(s), the DRB(s) associated with the QoS flow(s), or both, with the updated QoS configuration. In some examples, the second message is a data packet with the QoS Flow ID in the SDAP header and a “reverse reflective QoS” flag in the header. In some examples, the second message may be configured to be forwarded by the RAN access 404 to the UPF 412 with a header that indicates the updated session binding as associated with uplink packet(s) of the data session. In this example, the RAN access 404 may set a header field in the packet carrying the second message to the UPF 412. The header field could be a GTP-U header, and it is set by the RAN access 404 when it receives the second message from UE 402 with the “reverse reflective QoS” indication. This first option may be considered, in some cases, as a hop-by-hop approach for the user plane where the UE indicates in the AS layer protocol (e.g., SDAP message header) that a new binding association is being created based on this packet (e.g., a reverse reflective indication). The RAN may add the indication in a GTP-U header to the UPF 412 (e.g., the RAN may decide to set the indication based on a QoS profile authorization). For example, at 440 the RAN 404 may transmit or otherwise output (and the UPF 412 may receive or otherwise obtain) a message that carries or otherwise conveys an indication of the QoS flow binding update. In some example, the indication may be provided in a GTP-U header of a packet.

In some examples, the UPF 412 may adapt the downlink session binding based on receiving the second message. For example, the updated session biding in the second message may be configured for use by the UPF 412 to determine an updated session binding associated with downlink packet(s) of the data session. Thus, in this example the UPF 412 may obtain a user plane packet that indicates a reflective flow mapping update and determine an updated session binding associated with uplink packet(s) of the data session. The UPF 412 may then apply the updated binding to the downlink packet(s) of the data session. In this example, the UPF 412 may adapt various parameters of the QoS configuration for the QoS flow(s) for downlink traffic based on the updated QoS configuration provided by the UE 402 for the uplink traffic. In this example, the UPF 412 after receiving the second message with the indication of “reverse reflective QoS” would obtain the information about the data packet associated with the second message, e.g., transport protocol types, source and destination IP addresses/prefixes, source and destination port numbers, IPSec SPI, Ethernet addresses, etc. The data packet may be contained inside the second message. The UPF 412 obtains also the information associated with the QoS Flow(s) and PDU sessions for the second message, e.g., by checking the GTP-U tunnel ID and the flow identifiers and that of the flexible QoS Configuration information received from SMF 408 previously. The UPF creates a corresponding downlink data flow to QoS Flow(s) and PDU session binding using the information, e.g., by reversing the source and destination information of the IP addresses/prefixes, port numbers, etc.

A second option is shown at 442 and includes, in some cases, as a direct communication between the UE 402 and the UPF 412 which may include a user plane data packet from UE 402 to UPF 412 with a user plane protocol header indicating the reverse reflective QoS indication. For example, in case of the user plane data packet is using the IP transport, the indication may be an IP header option inserted by UE 402 and verified by UPF 412. In case the user plane data packet is using Ethernet transport, the indication may be an additional Ethernet header bit that indicates the reverse reflective QoS indication. In case the user plane data packet is unstructured, the indication may be included in a meta layer encapsulating the data packet that is used for carrying additional information to the UPF 412, e.g., NIDD protocol. Once the UPF 412 received the second message, i.e. the user plane data packet with the indication, it generates the downlink traffic binding accordingly by checking the corresponding uplink QoS Flow(s) and PDU session association used to transport the second message. The UPF 412 uses the downlink traffic binding information to handle the downlink packets and association with the QoS Flows to the UE 402. Once the UE receives downlink packets according to the updated QoS Flow(s) association of the second message, it can stop including the indication in further uplink data packets.

A third option is shown at 444 where the second message includes a QoS rule adjustment message that is output to (e.g., configured to be forwarded by the RAN 404) the UPF 412. For example, the UE 402 may transmit or otherwise output (and the UPF 412 may receive or otherwise obtain) the second message that is carried over user plane towards the UPF 412. This second message may be carried over the default QoS Flows of the PDU session associated with the UPF 412. In some examples, the second message may include the direct adaptation information for the uplink traffic or may include a reflective indicator for the QoS flow binding (e.g., used to adapt the QoS configurations for the QoS flow(s) for downlink traffic). In some other examples, the second message may include an instruction for the UPF 412 to update the downlink traffic binding and the corresponding data traffic and QoS Flow(s) association, e.g., downlink data packet filters. In either case, at 446 the UPF 412 may update downlink PDRs associated with the QoS configuration according to the QoS rule adjustment message. This third option may be considered, in some cases, as the direct communication between the UE 402 and the UPF 412 which may include configuring an API at the UPF 412 for the UE 402 to send the new configuration to directly. The UE 402 and UPF 412 may use a suitable protocol for realizing the API, e.g., a web API based on HTTP(/S) or SIP.

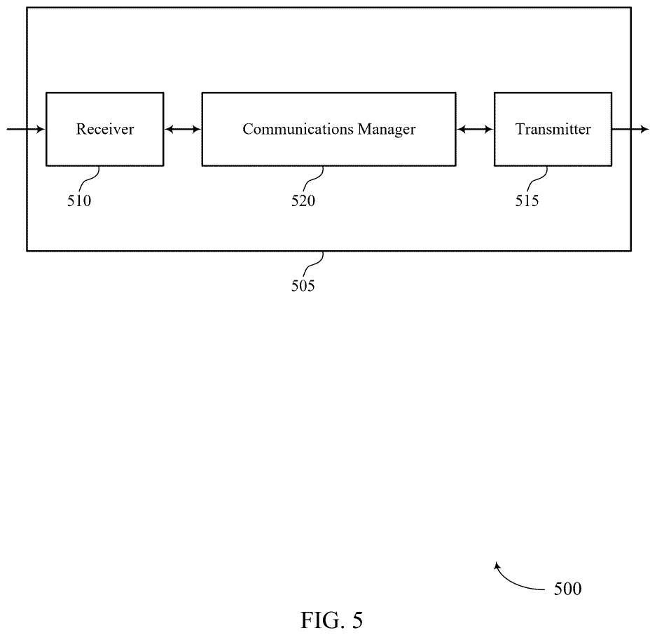

FIG. 5 shows a block diagram 500 of a device 505 that supports AI native QoS flow binding in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to AI native QoS flow binding). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to AI native QoS flow binding). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of AI native QoS flow binding as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a first message identifying a QoS configuration associated with one or more QoS flows of a data session, the first message further identifying the QoS configuration as a flexible QoS configuration. The communications manager 520 is capable of, configured to, or operable to support a means for transmitting a second message identifying an updated QoS configuration for the one or more QoS flows based on performance metrics determined by the UE and the QoS configuration being a flexible QoS configuration, the updated QoS configuration being different from the QoS configuration and including an updated session binding. The communications manager 520 is capable of, configured to, or operable to support a means for performing wireless communications for the data session using the one or more QoS flows according to the updated QoS configuration.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for UE-centric adaptation of the QoS configuration for the QoS flow(s) or DRB(s) associated with a data session. This may include the network configuring a flexible QoS configuration for the data session and the UE using a native AI/ML model to predict and initiate updating the QoS configuration.

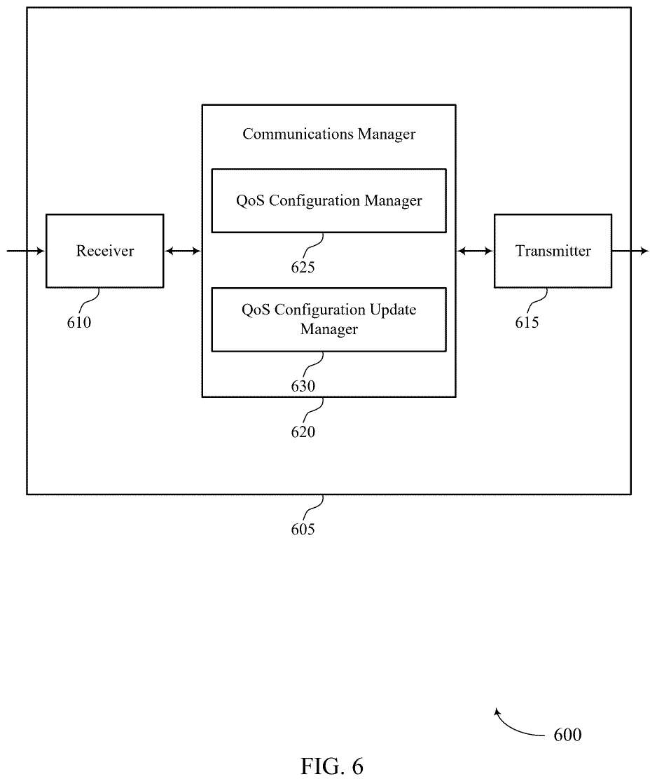

FIG. 6 shows a block diagram 600 of a device 605 that supports AI native QoS flow binding in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to AI native QoS flow binding). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to AI native QoS flow binding). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of AI native QoS flow binding as described herein. For example, the communications manager 620 may include a QoS configuration manager 625 a QoS configuration update manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The QoS configuration manager 625 is capable of, configured to, or operable to support a means for receiving a first message identifying a QoS configuration associated with one or more QoS flows of a data session, the first message further identifying the QoS configuration as a flexible QoS configuration. The QoS configuration update manager 630 is capable of, configured to, or operable to support a means for transmitting a second message identifying an updated QoS configuration for the one or more QoS flows based on performance metrics determined by the UE and the QoS configuration being a flexible QoS configuration, the updated QoS configuration being different from the QoS configuration and including an updated session binding. The QoS configuration update manager 630 is capable of, configured to, or operable to support a means for performing wireless communications for the data session using the one or more QoS flows according to the updated QoS configuration.

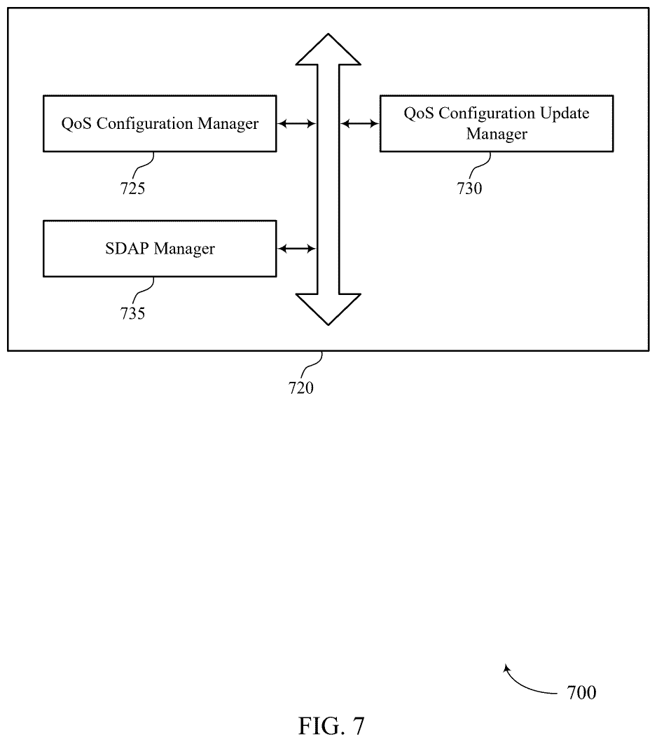

FIG. 7 shows a block diagram 700 of a communications manager 720 that supports AI native QoS flow binding in accordance with one or more aspects of the present disclosure. The communications manager 720 may be an example of aspects of a communications manager 520, a communications manager 620, or both, as described herein. The communications manager 720, or various components thereof, may be an example of means for performing various aspects of AI native QoS flow binding as described herein. For example, the communications manager 720 may include a QoS configuration manager 725, a QoS configuration update manager 730, an SDAP manager 735, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The QoS configuration manager 725 is capable of, configured to, or operable to support a means for receiving a first message identifying a QoS configuration associated with one or more QoS flows of a data session, the first message further identifying the QoS configuration as a flexible QoS configuration. The QoS configuration update manager 730 is capable of, configured to, or operable to support a means for transmitting a second message identifying an updated QoS configuration for the one or more QoS flows based on performance metrics determined by the UE and the QoS configuration being a flexible QoS configuration, the updated QoS configuration being different from the QoS configuration and including an updated session binding. In some examples, the QoS configuration update manager 730 is capable of, configured to, or operable to support a means for performing wireless communications for the data session using the one or more QoS flows according to the updated QoS configuration.

In some examples, the second message includes a SDAP message header, and the SDAP manager 735 is capable of, configured to, or operable to support a means for transmitting the SDAP message header that indicates the updated session binding, the second message further indicating information associating the one or more QoS flows, one or more data radio bearers associated with the one or more QoS flows, or both, with the updated QoS configuration. In some examples, the second message is configured to be forwarded by a RAN to a UPF with a header indicating an updated session binding is associated with one or more uplink packets of the data session.

In some examples, the updated session binding associated with one or more uplink packets of the data session in the second message is configured for use by a UPF to determine an updated session binding associated with one or more downlink packets of the data session. In some examples, the second message includes a QoS rule adjustment message that is configured to be forwarded by the RAN to a SMF within a core network. In some examples, the QoS rule adjustment message is associated with service flow binding and mapping information updates for QoS flows having a flexible QoS configuration indicated in the first message. In some examples, the second message includes a QoS rule adjustment message that is configured to be forwarded by the RAN to a UPF within a core network.

In some examples, the first message that indicates a flexible QoS configuration includes multiple alternative QoS rule sets. In some examples, the updated QoS configuration indicates a QoS rule selected from the multiple alternative QoS rule sets by the UE based on the performance metrics determined by the UE. In some examples, the flexible QoS configuration configures the UE to determine, from a set of multiple mappings identified in the QoS configuration, service flow binding and mapping information.

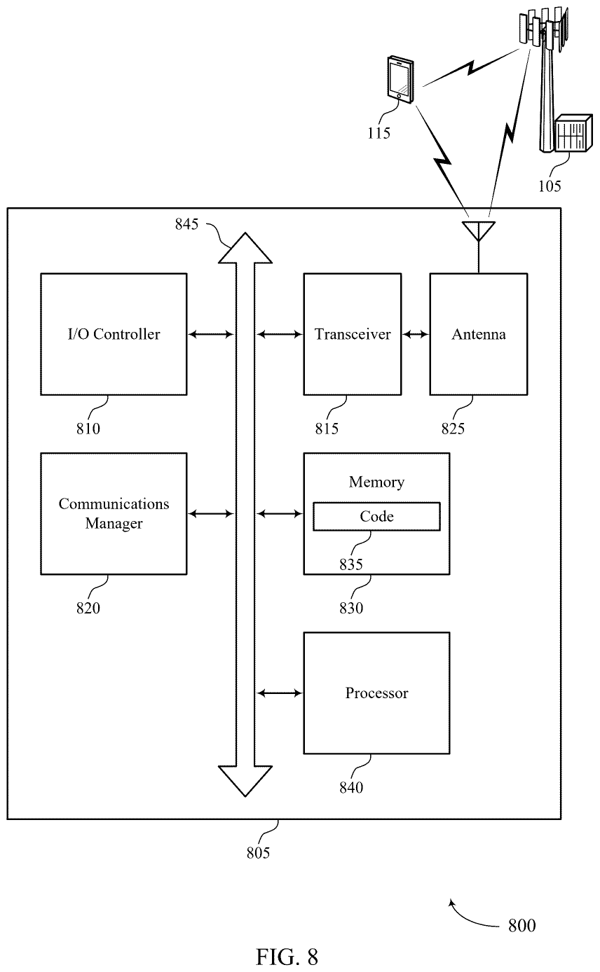

FIG. 8 shows a diagram of a system 800 including a device 805 that supports AI native QoS flow binding in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting AI native QoS flow binding). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a first message identifying a QoS configuration associated with one or more QoS flows of a data session, the first message further identifying the QoS configuration as a flexible QoS configuration. The communications manager 820 is capable of, configured to, or operable to support a means for transmitting a second message identifying an updated QoS configuration for the one or more QoS flows based on performance metrics determined by the UE and the QoS configuration being a flexible QoS configuration, the updated QoS configuration being different from the QoS configuration and including an updated session binding. The communications manager 820 is capable of, configured to, or operable to support a means for performing wireless communications for the data session using the one or more QoS flows according to the updated QoS configuration.

By including or configuring the communications manager 820 in accordance with examples as described herein, the device 805 may support techniques for UE-centric adaptation of the QoS configuration for the QoS flow(s) or DRB(s) associated with a data session. This may include the network configuring a flexible QoS configuration for the data session and the UE using a native AI/ML model to predict and initiate updating the QoS configuration.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of AI native QoS flow binding as described herein, or the at least one processor 840 and the at least one memory 830 may be otherwise configured to, individually or collectively, perform or support such operations.

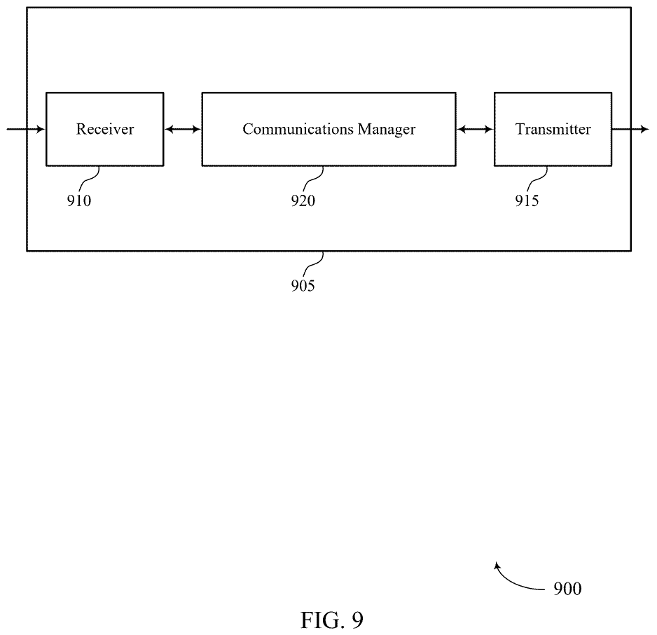

FIG. 9 shows a block diagram 900 of a device 905 that supports AI native QoS flow binding in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of AI native QoS flow binding as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting, to a UE, a first message identifying a QoS configuration associated with one or more QoS flows of a data session, the first message further identifying the QoS configuration as a flexible QoS configuration. The communications manager 920 is capable of, configured to, or operable to support a means for obtaining, from the UE, a second message identifying an updated QoS configuration for the one or more QoS flows, the updated QoS configuration based on performance metrics associated with the UE and the QoS configuration being a flexible QoS configuration, the updated QoS configuration being different from the QoS configuration and including an updated session binding. The communications manager 920 is capable of, configured to, or operable to support a means for performing wireless communications for the data session using the one or more QoS flows according to the updated QoS configuration.

Additionally, or alternatively, the communications manager 920 may support wireless communications in accordance with examples as disclosed herein. For example, the communications manager 920 is capable of, configured to, or operable to support a means for outputting, to a UPF within the core network, a session establishment message that identifies a flexible packet detection rule for a QoS configuration associated with one or more QoS flows of a data session for a UE, the flexible packet detection rule identifying the QoS configuration as a flexible QoS configuration. The communications manager 920 is capable of, configured to, or operable to support a means for outputting, to a network entity associated with the UE, a message that identifies the QoS configuration, where the message further identifies the QoS configuration as the flexible QoS configuration.

Additionally, or alternatively, the communications manager 920 may support wireless communications in accordance with examples as disclosed herein. For example, the communications manager 920 is capable of, configured to, or operable to support a means for obtaining, from a SMF network entity within the core network, a session establishment message that identifies a flexible packet detection rule for a QoS configuration associated with one or more QoS flows of a data session for a UE, the flexible packet detection rule identifying the QoS configuration as a flexible QoS configuration. The communications manager 920 is capable of, configured to, or operable to support a means for outputting, to the SMF network entity, a response message that identifies the QoS configuration.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for UE-centric adaptation of the QoS configuration for the QoS flow(s) or DRB(s) associated with a data session. This may include the network configuring a flexible QoS configuration for the data session and the UE using a native AI/ML model to predict and initiate updating the QoS configuration.

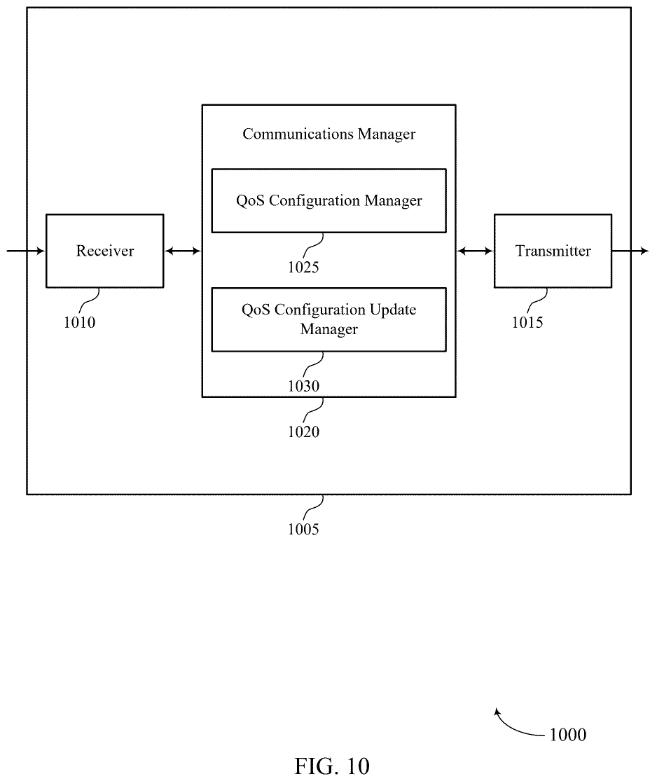

FIG. 10 shows a block diagram 1000 of a device 1005 that supports AI native QoS flow binding in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of AI native QoS flow binding as described herein. For example, the communications manager 1020 may include a QoS configuration manager 1025 a QoS configuration update manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The QoS configuration manager 1025 is capable of, configured to, or operable to support a means for outputting, to a UE, a first message identifying a QoS configuration associated with one or more QoS flows of a data session, the first message further identifying the QoS configuration as a flexible QoS configuration. The QoS configuration update manager 1030 is capable of, configured to, or operable to support a means for obtaining, from the UE, a second message identifying an updated QoS configuration for the one or more QoS flows, the updated QoS configuration based on performance metrics associated with the UE and the QoS configuration being a flexible QoS configuration, the updated QoS configuration being different from the QoS configuration and including an updated session binding. The QoS configuration update manager 1030 is capable of, configured to, or operable to support a means for performing wireless communications for the data session using the one or more QoS flows according to the updated QoS configuration.

Additionally, or alternatively, the communications manager 1020 may support wireless communications in accordance with examples as disclosed herein. The QoS configuration manager 1025 is capable of, configured to, or operable to support a means for outputting, to a UPF within the core network, a session establishment message that identifies a flexible packet detection rule for a QoS configuration associated with one or more QoS flows of a data session for a UE, the flexible packet detection rule identifying the QoS configuration as a flexible QoS configuration. The QoS configuration update manager 1030 is capable of, configured to, or operable to support a means for outputting, to a network entity associated with the UE, a message that identifies the QoS configuration, where the message further identifies the QoS configuration as the flexible QoS configuration.

Additionally, or alternatively, the communications manager 1020 may support wireless communications in accordance with examples as disclosed herein. The QoS configuration update manager 1030 is capable of, configured to, or operable to support a means for obtaining, from a SMF network entity within the core network, a session establishment message that identifies a flexible packet detection rule for a QoS configuration associated with one or more QoS flows of a data session for a UE, the flexible packet detection rule identifying the QoS configuration as a flexible QoS configuration. The QoS configuration manager 1025 is capable of, configured to, or operable to support a means for outputting, to the SMF network entity, a response message that identifies the QoS configuration.

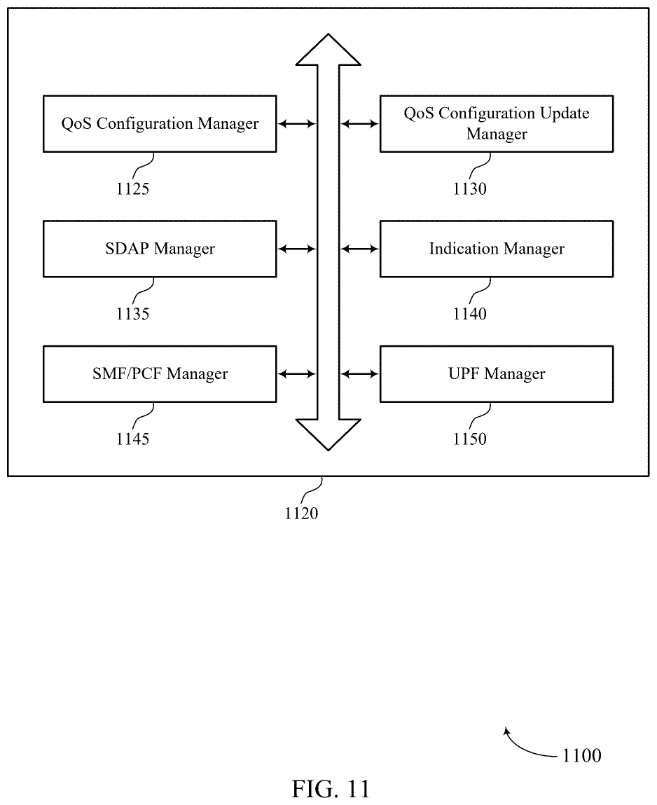

FIG. 11 shows a block diagram 1100 of a communications manager 1120 that supports AI native QoS flow binding in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of AI native QoS flow binding as described herein. For example, the communications manager 1120 may include a QoS configuration manager 1125, a QoS configuration update manager 1130, an SDAP manager 1135, an indication manager 1140, an SMF/PCF manager 1145, a UPF manager 1150, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The QoS configuration manager 1125 is capable of, configured to, or operable to support a means for outputting, to a UE, a first message identifying a QoS configuration associated with one or more QoS flows of a data session, the first message further identifying the QoS configuration as a flexible QoS configuration. The QoS configuration update manager 1130 is capable of, configured to, or operable to support a means for obtaining, from the UE, a second message identifying an updated QoS configuration for the one or more QoS flows, the updated QoS configuration based on performance metrics associated with the UE and the QoS configuration being a flexible QoS configuration, the updated QoS configuration being different from the QoS configuration and including an updated session binding. In some examples, the QoS configuration update manager 1130 is capable of, configured to, or operable to support a means for performing wireless communications for the data session using the one or more QoS flows according to the updated QoS configuration.

In some examples, the second message includes a SDAP message header, and the SDAP manager 1135 is capable of, configured to, or operable to support a means for obtaining the SDAP message header that indicates the updated session binding, the second message further indicating information associating the one or more QoS flows, one or more data radio bearers associated with the one or more QoS flows, or both, with the updated QoS configuration, where the second message is forwarded by the network entity to a UPF with a header indicating an updated session binding is associated with one or more uplink packets of the data session.

In some examples, the indication manager 1140 is capable of, configured to, or operable to support a means for obtaining an indication that the QoS configuration is the flexible QoS configuration from a SMF within a core network associated with the network entity. In some examples, the first message indicates a flexible packet filter for a QoS rule of the QoS configuration that is set to a value that defines the QoS configuration as the flexible QoS configuration. In some examples, the updated QoS configuration defines the QoS rule for the flexible packet filter having a threshold QoS precedence level. In some examples, the flexible QoS configuration configures the UE to determine, from a set of multiple mappings identified in the QoS configuration, service flow binding and mapping information.

Additionally, or alternatively, the communications manager 1120 may support wireless communications in accordance with examples as disclosed herein. In some examples, the QoS configuration manager 1125 is capable of, configured to, or operable to support a means for outputting, to a UPF within the core network, a session establishment message that identifies a flexible packet detection rule for a QoS configuration associated with one or more QoS flows of a data session for a UE, the flexible packet detection rule identifying the QoS configuration as a flexible QoS configuration. In some examples, the QoS configuration update manager 1130 is capable of, configured to, or operable to support a means for outputting, to a network entity associated with the UE, a message that identifies the QoS configuration, where the message further identifies the QoS configuration as the flexible QoS configuration.

In some examples, the SMF/PCF manager 1145 is capable of, configured to, or operable to support a means for obtaining, from the UE, a QoS rule adjustment message that identifies an updated QoS configuration for the one or more QoS flows based on performance metrics associated with the UE. In some examples, the SMF/PCF manager 1145 is capable of, configured to, or operable to support a means for outputting, to the UPF, an updated packet detection rule in accordance with the updated QoS configuration. In some examples, the SMF/PCF manager 1145 is capable of, configured to, or operable to support a means for outputting, to the network entity, a QoS profile update confirmation message according to the updated packet detection rule. In some examples, the flexible packet detection rule identifies the QoS configuration as the flexible QoS configuration according to a set of alternative QFIs, a set of alternative PDU session identifiers, or both. In some examples, the flexible QoS configuration configures the UE to determine, from a set of multiple mappings identified in the QoS configuration, service flow binding and mapping information.

Additionally, or alternatively, the communications manager 1120 may support wireless communications in accordance with examples as disclosed herein. In some examples, the QoS configuration update manager 1130 is capable of, configured to, or operable to support a means for obtaining, from a SMF network entity within the core network, a session establishment message that identifies a flexible packet detection rule for a QoS configuration associated with one or more QoS flows of a data session for a UE, the flexible packet detection rule identifying the QoS configuration as a flexible QoS configuration. In some examples, the QoS configuration manager 1125 is capable of, configured to, or operable to support a means for outputting, to the SMF network entity, a response message that identifies the QoS configuration.

In some examples, the UPF manager 1150 is capable of, configured to, or operable to support a means for obtaining, from the UE, a user plane packet that indicates a reflective flow mapping update. In some examples, the UPF manager 1150 is capable of, configured to, or operable to support a means for determining, based on the user plane packet, an updated binding associated with one or more uplink packets of the data session. In some examples, the UPF manager 1150 is capable of, configured to, or operable to support a means for applying the updated binding to one or more downlink packets of the data session.

In some examples, the UPF manager 1150 is capable of, configured to, or operable to support a means for obtaining, from the UE, an QoS rule adjustment message associated with one or more uplink packets of the data session. In some examples, the UPF manager 1150 is capable of, configured to, or operable to support a means for updating one or more downlink packet detection rules associated with the QoS configuration in accordance with the QoS rule adjustment message. In some examples, the flexible packet detection rule identifies the QoS configuration as the flexible QoS configuration according to a set of alternative QFIs, a set of alternative PDU session identifiers, or both. In some examples, the flexible QoS configuration configures the UE to determine, from a set of multiple mappings identified in the QoS configuration, service flow binding and mapping information.

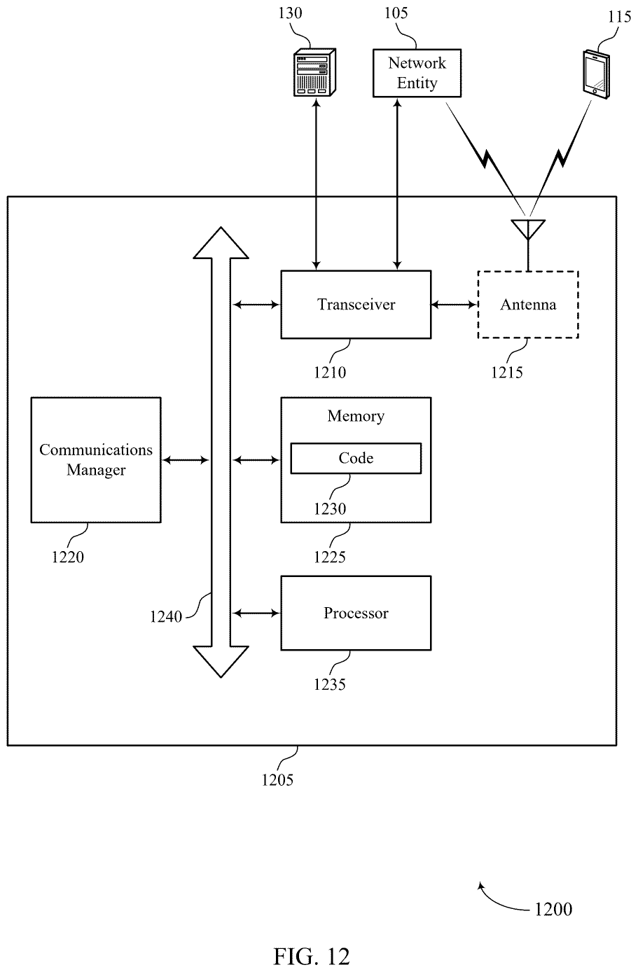

FIG. 12 shows a diagram of a system 1200 including a device 1205 that supports AI native QoS flow binding in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting AI native QoS flow binding). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting, to a UE, a first message identifying a QoS configuration associated with one or more QoS flows of a data session, the first message further identifying the QoS configuration as a flexible QoS configuration. The communications manager 1220 is capable of, configured to, or operable to support a means for obtaining, from the UE, a second message identifying an updated QoS configuration for the one or more QoS flows, the updated QoS configuration based on performance metrics associated with the UE and the QoS configuration being a flexible QoS configuration, the updated QoS configuration being different from the QoS configuration and including an updated session binding. The communications manager 1220 is capable of, configured to, or operable to support a means for performing wireless communications for the data session using the one or more QoS flows according to the updated QoS configuration.

Additionally, or alternatively, the communications manager 1220 may support wireless communications in accordance with examples as disclosed herein. For example, the communications manager 1220 is capable of, configured to, or operable to support a means for outputting, to a UPF within the core network, a session establishment message that identifies a flexible packet detection rule for a QoS configuration associated with one or more QoS flows of a data session for a UE, the flexible packet detection rule identifying the QoS configuration as a flexible QoS configuration. The communications manager 1220 is capable of, configured to, or operable to support a means for outputting, to a network entity associated with the UE, a message that identifies the QoS configuration, where the message further identifies the QoS configuration as the flexible QoS configuration.

Additionally, or alternatively, the communications manager 1220 may support wireless communications in accordance with examples as disclosed herein. For example, the communications manager 1220 is capable of, configured to, or operable to support a means for obtaining, from a SMF network entity within the core network, a session establishment message that identifies a flexible packet detection rule for a QoS configuration associated with one or more QoS flows of a data session for a UE, the flexible packet detection rule identifying the QoS configuration as a flexible QoS configuration. The communications manager 1220 is capable of, configured to, or operable to support a means for outputting, to the SMF network entity, a response message that identifies the QoS configuration.

By including or configuring the communications manager 1220 in accordance with examples as described herein, the device 1205 may support techniques for UE-centric adaptation of the QoS configuration for the QoS flow(s) or DRB(s) associated with a data session. This may include the network configuring a flexible QoS configuration for the data session and the UE using a native AI/ML model to predict and initiate updating the QoS configuration.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of AI native QoS flow binding as described herein, or the at least one processor 1235 and the at least one memory 1225 may be otherwise configured to, individually or collectively, perform or support such operations.

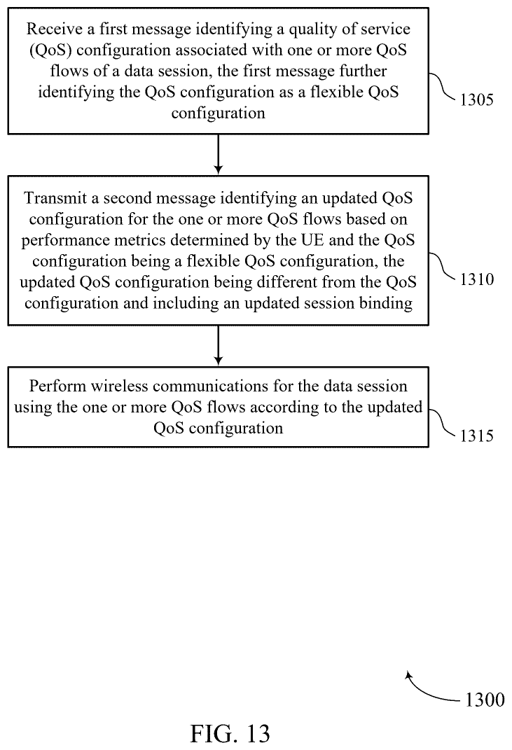

FIG. 13 shows a flowchart illustrating a method 1300 that supports AI native QoS flow binding in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a first message identifying a QoS configuration associated with one or more QoS flows of a data session, the first message further identifying the QoS configuration as a flexible QoS configuration. The operations of 1305 may be performed in accordance with examples as disclosed herein. In some examples, aspects of the operations of 1305 may be performed by a QoS configuration manager 725 as described with reference to FIG. 7.

At 1310, the method may include transmitting a second message identifying an updated QoS configuration for the one or more QoS flows based on performance metrics determined by the UE and the QoS configuration being a flexible QoS configuration, the updated QoS configuration being different from the QoS configuration and including an updated session binding. The operations of 1310 may be performed in accordance with examples as disclosed herein. In some examples, aspects of the operations of 1310 may be performed by a QoS configuration update manager 730 as described with reference to FIG. 7.

At 1315, the method may include performing wireless communications for the data session using the one or more QoS flows according to the updated QoS configuration. The operations of 1315 may be performed in accordance with examples as disclosed herein. In some examples, aspects of the operations of 1315 may be performed by a QoS configuration update manager 730 as described with reference to FIG. 7.

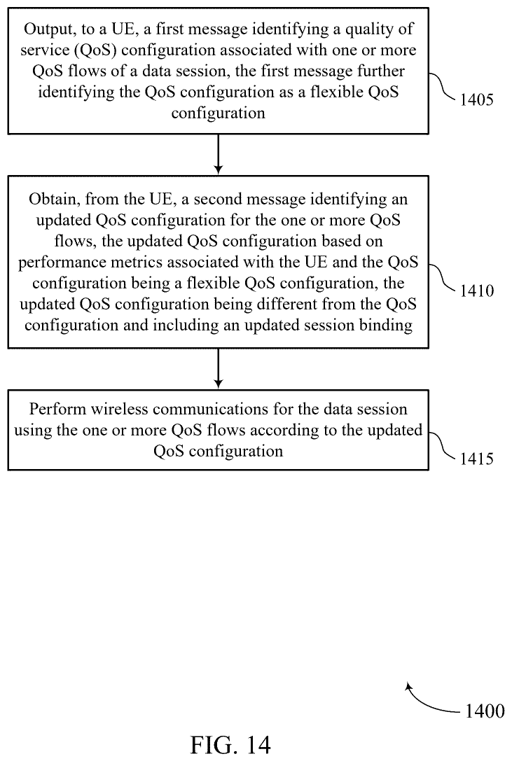

FIG. 14 shows a flowchart illustrating a method 1400 that supports AI native QoS flow binding in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include outputting, to a UE, a first message identifying a QoS configuration associated with one or more QoS flows of a data session, the first message further identifying the QoS configuration as a flexible QoS configuration. The operations of 1405 may be performed in accordance with examples as disclosed herein. In some examples, aspects of the operations of 1405 may be performed by a QoS configuration manager 1125 as described with reference to FIG. 11.

At 1410, the method may include obtaining, from the UE, a second message identifying an updated QoS configuration for the one or more QoS flows, the updated QoS configuration based on performance metrics associated with the UE and the QoS configuration being a flexible QoS configuration, the updated QoS configuration being different from the QoS configuration and including an updated session binding. The operations of 1410 may be performed in accordance with examples as disclosed herein. In some examples, aspects of the operations of 1410 may be performed by a QoS configuration update manager 1130 as described with reference to FIG. 11.

At 1415, the method may include performing wireless communications for the data session using the one or more QoS flows according to the updated QoS configuration. The operations of 1415 may be performed in accordance with examples as disclosed herein. In some examples, aspects of the operations of 1415 may be performed by a QoS configuration update manager 1130 as described with reference to FIG. 11.

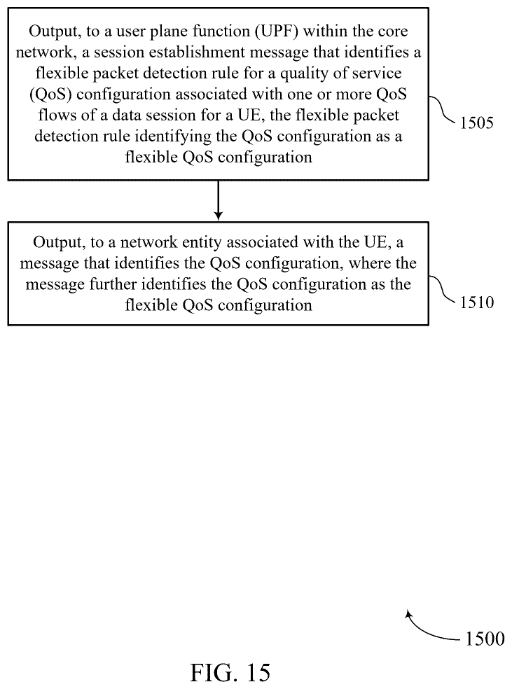

FIG. 15 shows a flowchart illustrating a method 1500 that supports AI native QoS flow binding in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to a UPF within the core network, a session establishment message that identifies a flexible packet detection rule for a QoS configuration associated with one or more QoS flows of a data session for a UE, the flexible packet detection rule identifying the QoS configuration as a flexible QoS configuration. The operations of 1505 may be performed in accordance with examples as disclosed herein. In some examples, aspects of the operations of 1505 may be performed by a QoS configuration manager 1125 as described with reference to FIG. 11.

At 1510, the method may include outputting, to a network entity associated with the UE, a message that identifies the QoS configuration, where the message further identifies the QoS configuration as the flexible QoS configuration. The operations of 1510 may be performed in accordance with examples as disclosed herein. In some examples, aspects of the operations of 1510 may be performed by a QoS configuration update manager 1130 as described with reference to FIG. 11.

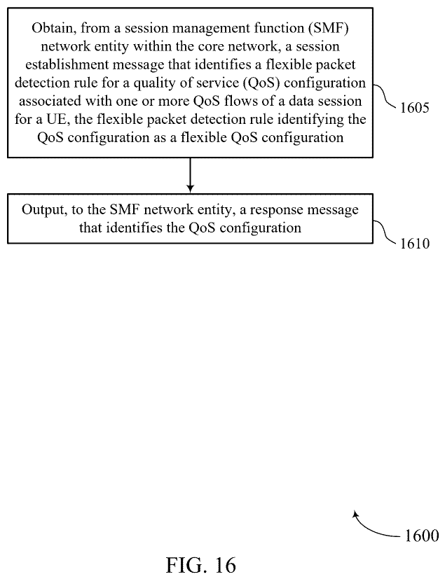

FIG. 16 shows a flowchart illustrating a method 1600 that supports AI native QoS flow binding in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include obtaining, from a SMF network entity within the core network, a session establishment message that identifies a flexible packet detection rule for a QoS configuration associated with one or more QoS flows of a data session for a UE, the flexible packet detection rule identifying the QoS configuration as a flexible QoS configuration. The operations of 1605 may be performed in accordance with examples as disclosed herein. In some examples, aspects of the operations of 1605 may be performed by a QoS configuration update manager 1130 as described with reference to FIG. 11.

At 1610, the method may include outputting, to the SMF network entity, a response message that identifies the QoS configuration. The operations of 1610 may be performed in accordance with examples as disclosed herein. In some examples, aspects of the operations of 1610 may be performed by a QoS configuration manager 1125 as described with reference to FIG. 11.

The following provides an overview of aspects of the present disclosure:
Aspect 1: A method for wireless communications at a UE, comprising: receiving a first message identifying a QoS configuration associated with one or more QoS flows of a data session, the first message further identifying the QoS configuration as a flexible QoS configuration; transmitting a second message identifying an updated QoS configuration for the one or more QoS flows based on performance metrics determined by the UE and the QoS configuration being a flexible QoS configuration, the updated QoS configuration being different from the QoS configuration and including an updated session binding; and performing wireless communications for the data session using the one or more QoS flows according to the updated QoS configuration.
Aspect 2: The method of aspect 1, wherein the second message comprises a SDAP message header, the method further comprising: transmitting the SDAP message header that indicates the updated session binding, the second message further indicating information associating the one or more QoS flows, one or more data radio bearers associated with the one or more QoS flows, or both, with the updated QoS configuration.
Aspect 3: The method of aspect 2, wherein the second message is configured to be forwarded by a RAN to a UPF with a header indicating an updated session binding is associated with one or more uplink packets of the data session.
Aspect 4: The method of any of aspects 2 through 3, wherein the updated session binding associated with one or more uplink packets of the data session in the second message is configured for use by a UPF to determine an updated session binding associated with one or more downlink packets of the data session.
Aspect 5: The method of any of aspects 1 through 4, wherein the second message comprises a QoS rule adjustment message that is configured to be forwarded by a RAN to a SMF within a core network.
Aspect 6: The method of aspect 5, wherein the QoS rule adjustment message is associated with service flow binding and mapping information updates for QoS flows having a flexible QoS configuration indicated in the first message.
Aspect 7: The method of any of aspects 1 through 6, wherein the second message comprises a QoS rule adjustment message that is configured to be forwarded by a RAN to a UPF within a core network.
Aspect 8: The method of any of aspects 1 through 7, wherein the first message that indicates a flexible QoS configuration comprises multiple alternative QoS rule sets, the updated QoS configuration indicates a QoS rule selected from the multiple alternative QoS rule sets by the UE based on the performance metrics determined by the UE.
Aspect 9: The method of any of aspects 1 through 8, wherein the flexible QoS configuration configures the UE to determine, from a plurality of mappings identified in the QoS configuration, service flow binding and mapping information.
Aspect 10: A method for wireless communications at a network entity, comprising: outputting, to a UE, a first message identifying a QoS configuration associated with one or more QoS flows of a data session, the first message further identifying the QoS configuration as a flexible QoS configuration; obtaining, from the UE, a second message identifying an updated QoS configuration for the one or more QoS flows, the updated QoS configuration based on performance metrics associated with the UE and the QoS configuration being a flexible QoS configuration, the updated QoS configuration being different from the QoS configuration and including an updated session binding; and performing wireless communications for the data session using the one or more QoS flows according to the updated QoS configuration.
Aspect 11: The method of aspect 10, wherein the second message comprises a SDAP message header, the method further comprising: obtaining the SDAP message header that indicates the updated session binding, the second message further indicating information associating the one or more QoS flows, one or more data radio bearers associated with the one or more QoS flows, or both, with the updated QoS configuration, wherein the second message is forwarded by the network entity to a UPF with a header indicating an updated session binding is associated with one or more uplink packets of the data session.
Aspect 12: The method of any of aspects 10 through 11, further comprising: obtaining an indication that the QoS configuration is the flexible QoS configuration from a SMF within a core network associated with the network entity.
Aspect 13: The method of any of aspects 10 through 12, wherein the first message indicates a flexible packet filter for a QoS rule of the QoS configuration that is set to a value that defines the QoS configuration as the flexible QoS configuration, the updated QoS configuration defines the QoS rule for the flexible packet filter having a threshold QoS precedence level.
Aspect 14: The method of any of aspects 10 through 13, wherein the flexible QoS configuration configures the UE to determine, from a plurality of mappings identified in the QoS configuration, service flow binding and mapping information.
Aspect 15: A method for wireless communications at a network entity within a core network, comprising: outputting, to a UPF within the core network, a session establishment message that identifies a flexible packet detection rule for a QoS configuration associated with one or more QoS flows of a data session for a UE, the flexible packet detection rule identifying the QoS configuration as a flexible QoS configuration; and outputting, to a network entity associated with the UE, a message that identifies the QoS configuration, wherein the message further identifies the QoS configuration as the flexible QoS configuration.
Aspect 16: The method of aspect 15, further comprising: obtaining, from the UE, a QoS rule adjustment message that identifies an updated QoS configuration for the one or more QoS flows based on performance metrics associated with the UE; outputting, to the UPF, an updated packet detection rule in accordance with the updated QoS configuration; and outputting, to the network entity, a QoS profile update confirmation message according to the updated packet detection rule.
Aspect 17: The method of any of aspects 15 through 16, wherein the flexible packet detection rule identifies the QoS configuration as the flexible QoS configuration according to a set of alternative QFIs, a set of alternative PDU session identifiers, or both.
Aspect 18: The method of any of aspects 15 through 17, wherein the flexible QoS configuration configures the UE to determine, from a plurality of mappings identified in the QoS configuration, service flow binding and mapping information.
Aspect 19: A method for wireless communications at a user plane network entity within a core network, comprising: obtaining, from a SMF network entity within the core network, a session establishment message that identifies a flexible packet detection rule for a QoS configuration associated with one or more QoS flows of a data session for a UE, the flexible packet detection rule identifying the QoS configuration as a flexible QoS configuration; and outputting, to the SMF network entity, a response message that identifies the QoS configuration.
Aspect 20: The method of aspect 19, further comprising: obtaining, from the UE, a user plane packet that indicates a reflective flow mapping update; determining, based on the user plane packet, an updated binding associated with one or more uplink packets of the data session; and applying the updated binding to one or more downlink packets of the data session.
Aspect 21: The method of any of aspects 19 through 20, further comprising: obtaining, from the UE, an QoS rule adjustment message associated with one or more uplink packets of the data session; and updating one or more downlink packet detection rules associated with the QoS configuration in accordance with the QoS rule adjustment message.
Aspect 22: The method of any of aspects 19 through 21, wherein the flexible packet detection rule identifies the QoS configuration as the flexible QoS configuration according to a set of alternative QFIs, a set of alternative PDU session identifiers, or both.
Aspect 23: The method of any of aspects 19 through 22, wherein the flexible QoS configuration configures the UE to determine, from a plurality of mappings identified in the QoS configuration, service flow binding and mapping information.
Aspect 24: A UE for wireless communications, comprising one or more memories storing processor-executable code, and one or more processors coupled with the one or more memories and individually or collectively operable to execute the code to cause the UE to perform a method of any of aspects 1 through 9.
Aspect 25: A UE for wireless communications, comprising at least one means for performing a method of any of aspects 1 through 9.
Aspect 26: A non-transitory computer-readable medium storing code for wireless communications, the code comprising instructions executable by one or more processors to perform a method of any of aspects 1 through 9.
Aspect 27: A network entity for wireless communications, comprising one or more memories storing processor-executable code, and one or more processors coupled with the one or more memories and individually or collectively operable to execute the code to cause the network entity to perform a method of any of aspects 10 through 14.
Aspect 28: A network entity for wireless communications, comprising at least one means for performing a method of any of aspects 10 through 14.
Aspect 29: A non-transitory computer-readable medium storing code for wireless communications, the code comprising instructions executable by one or more processors to perform a method of any of aspects 10 through 14.
Aspect 30: A network entity within a core network for wireless communications, comprising one or more memories storing processor-executable code, and one or more processors coupled with the one or more memories and individually or collectively operable to execute the code to cause the network entity within a core network to perform a method of any of aspects 15 through 18.
Aspect 31: A network entity within a core network for wireless communications, comprising at least one means for performing a method of any of aspects 15 through 18.
Aspect 32: A non-transitory computer-readable medium storing code for wireless communications, the code comprising instructions executable by one or more processors to perform a method of any of aspects 15 through 18.
Aspect 33: A user plane network entity within a core network for wireless communications, comprising one or more memories storing processor-executable code, and one or more processors coupled with the one or more memories and individually or collectively operable to execute the code to cause the user plane network entity within a core network to perform a method of any of aspects 19 through 23.
Aspect 34: A user plane network entity within a core network for wireless communications, comprising at least one means for performing a method of any of aspects 19 through 23.
Aspect 35: A non-transitory computer-readable medium storing code for wireless communications, the code comprising instructions executable by one or more processors to perform a method of any of aspects 19 through 23.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first message identifying a quality of service (QoS) configuration associated with one or more QoS flows of a data session, the first message further identifying the QoS configuration as a flexible QoS configuration;
transmit a second message identifying an updated QoS configuration for the one or more QoS flows based on performance metrics determined by the UE and the QoS configuration being a flexible QoS configuration, the updated QoS configuration being different from the QoS configuration and including an updated session binding; and
perform wireless communications for the data session using the one or more QoS flows according to the updated QoS configuration.

2. The UE of claim 1, wherein the second message comprises a service data adaptation protocol (SDAP) message header, and the one or more processors are individually or collectively further operable to execute the code to cause the UE to:
transmit the SDAP message header that indicates the updated session binding, the second message further indicating information associating the one or more QoS flows, one or more data radio bearers associated with the one or more QoS flows, or both, with the updated QoS configuration.

3. The UE of claim 2, wherein the second message is configured to be forwarded by a radio network entity (RAN) to a user plane function (UPF) with a header indicating an updated session binding is associated with one or more uplink packets of the data session.

4. The UE of claim 2, wherein the updated session binding associated with one or more uplink packets of the data session in the second message is configured for use by a user plane function (UPF) to determine an updated session binding associated with one or more downlink packets of the data session.

5. The UE of claim 1, wherein the second message comprises a QoS rule adjustment message that is configured to be forwarded by a radio access network (RAN) to a session management function (SMF) within a core network.

6. The UE of claim 5, wherein the QoS rule adjustment message is associated with service flow binding and mapping information updates for QoS flows having a flexible QoS configuration indicated in the first message.

7. The UE of claim 1, wherein the second message comprises a QoS rule adjustment message that is configured to be forwarded by a radio access network (RAN) to a user plane function (UPF) within a core network.

8. The UE of claim 1, wherein the first message that indicates a flexible QoS configuration comprises multiple alternative QoS rule sets, and the updated QoS configuration indicates a QoS rule selected from the multiple alternative QoS rule sets by the UE based on the performance metrics determined by the UE.

9. The UE of claim 1, wherein the flexible QoS configuration configures the UE to determine, from a plurality of mappings identified in the QoS configuration, service flow binding and mapping information.

10. A network entity, comprising:
one or more memories storing processor-executable code; and
one or more processors coupled with the one or more memories and individually or collectively operable to execute the code to cause the network entity to:
output, to a user equipment (UE), a first message identifying a quality of service (QoS) configuration associated with one or more QoS flows of a data session, the first message further identifying the QoS configuration as a flexible QoS configuration;
obtain, from the UE, a second message identifying an updated QoS configuration for the one or more QoS flows, the updated QoS configuration based on performance metrics associated with the UE and the QoS configuration being a flexible QoS configuration, the updated QoS configuration being different from the QoS configuration and including an updated session binding; and
perform wireless communications for the data session using the one or more QoS flows according to the updated QoS configuration.

11. The network entity of claim 10, wherein the second message comprises a service data adaptation protocol (SDAP) message header, and the one or more processors are individually or collectively further operable to execute the code to cause the network entity to:
obtain the SDAP message header that indicates the updated session binding, the second message further indicating information associating the one or more QoS flows, one or more data radio bearers associated with the one or more QoS flows, or both, with the updated QoS configuration, wherein the second message is forwarded by the network entity to a user plane function (UPF) with a header indicating an updated session binding is associated with one or more uplink packets of the data session.

12. The network entity of claim 10, wherein the one or more processors are individually or collectively further operable to execute the code to cause the network entity to:
obtain an indication that the QoS configuration is the flexible QoS configuration from a session management function (SMF) within a core network associated with the network entity.

13. The network entity of claim 10, wherein the first message indicates a flexible packet filter for a QoS rule of the QoS configuration that is set to a value that defines the QoS configuration as the flexible QoS configuration, and the updated QoS configuration defines the QoS rule for the flexible packet filter having a threshold QoS precedence level.

14. The network entity of claim 10, wherein the flexible QoS configuration configures the UE to determine, from a plurality of mappings identified in the QoS configuration, service flow binding and mapping information.

15. A network entity within a core network, comprising:
one or more memories storing processor-executable code; and
one or more processors coupled with the one or more memories and individually or collectively operable to execute the code to cause the network entity within a core network to:
output, to a user plane function (UPF) within the core network, a session establishment message that identifies a flexible packet detection rule for a quality of service (QoS) configuration associated with one or more QoS flows of a data session for a user equipment (UE), the flexible packet detection rule identifying the QoS configuration as a flexible QoS configuration; and
output, to a network entity associated with the UE, a message that identifies the QoS configuration, wherein the message further identifies the QoS configuration as the flexible QoS configuration.

16. The network entity within a core network of claim 15, wherein the one or more processors are individually or collectively further operable to execute the code to cause the network entity within a core network to:
obtain, from the UE, a QoS rule adjustment message that identifies an updated QoS configuration for the one or more QoS flows based on performance metrics associated with the UE;
output, to the UPF, an updated packet detection rule in accordance with the updated QoS configuration; and
output, to the network entity, a QoS profile update confirmation message according to the updated packet detection rule.

17. The network entity within a core network of claim 15, wherein the flexible packet detection rule identifies the QoS configuration as the flexible QoS configuration according to a set of alternative QoS flow identifies (QFIs), a set of alternative protocol data unit (PDU) session identifiers, or both.

18. The network entity within a core network of claim 15, wherein the flexible QoS configuration configures the UE to determine, from a plurality of mappings identified in the QoS configuration, service flow binding and mapping information.

19. A user plane network entity within a core network, comprising:
one or more memories storing processor-executable code; and
one or more processors coupled with the one or more memories and individually or collectively operable to execute the code to cause the user plane network entity within a core network to:
obtain, from a session management function (SMF) network entity within the core network, a session establishment message that identifies a flexible packet detection rule for a quality of service (QoS) configuration associated with one or more QoS flows of a data session for a user equipment (UE), the flexible packet detection rule identifying the QoS configuration as a flexible QoS configuration; and
output, to the SMF network entity, a response message that identifies the QoS configuration.

20. The user plane network entity within a core network of claim 19, wherein the one or more processors are individually or collectively further operable to execute the code to cause the user plane network entity within a core network to:
obtain, from the UE, a user plane packet that indicates a reflective flow mapping update;
determine, based on the user plane packet, an updated binding associated with one or more uplink packets of the data session; and
apply the updated binding to one or more downlink packets of the data session.

21. The user plane network entity within a core network of claim 19, wherein the one or more processors are individually or collectively further operable to execute the code to cause the user plane network entity within a core network to:
obtain, from the UE, an QoS rule adjustment message associated with one or more uplink packets of the data session; and
update one or more downlink packet detection rules associated with the QoS configuration in accordance with the QoS rule adjustment message.

22. The user plane network entity within a core network of claim 19, wherein the flexible packet detection rule identifies the QoS configuration as the flexible QoS configuration according to a set of alternative QoS flow identifies (QFIs), a set of alternative protocol data unit (PDU) session identifiers, or both.

23. The user plane network entity within a core network of claim 19, wherein the flexible QoS configuration configures the UE to determine, from a plurality of mappings identified in the QoS configuration, service flow binding and mapping information.
